(19) United States
(12) Patent Application Publication
(10) Pub. No.: US 2026/0050172 A1
(43) Pub. Date: Feb. 19, 2026

(54) FIXATION MEMBER AND HEAD MOUNTED DISPLAY DEVICE INCLUDING THE SAME

(71) Applicant: Samsung Electronics Co., Ltd., Suwon-si (KR)

(72) Inventors: Myeongpil KIM, Suwon-si (KR); Donghak KIM, Suwon-si (KR); Kihee LEE, Suwon-si (KR)

(21) Appl. No.: 19/319,564

(22) Filed: Sep. 4, 2025

Related U.S. Application Data
(63) Continuation of application No. PCT/KR2025/012003, filed on Aug. 8, 2025.

(30) Foreign Application Priority Data
Aug. 13, 2024 (KR) 10-2024-0108287
Nov. 19, 2024 (KR) 10-2024-0165129

(51) Int. Cl. G02B 27/01; G02B 27/00

(52) U.S. Cl. CPC G02B 27/0176; G02B 27/0093; G02B 27/0172; G02B 2027/0138; G02B 2027/014; G02B 2027/0156; G02B 2027/0169; G02B 2027/0178

(57) ABSTRACT

A head mountable display device may include a wheel, a first plate coupled to the wheel and comprising a first seating groove, mountable a gear having a first surface disposed at the first plate, mountable a second plate disposed at a second surface of the gear, which is an opposite surface of the first surface of the gear, and comprising a plurality of second seating grooves along a circumference, and a fixation member having a first surface and a second surface which is an opposite surface of the first surface of the fixation member, wherein the fixation member comprises a protrusion, at least a portion of the first surface of the fixation member disposed in the first seating groove, and at least a portion of the second surface of the fixation member disposed in one of the plurality of second seating grooves, and a body extending from the protrusion. Various other embodiments are possible.

### CROSS-REFERENCE TO RELATED APPLICATIONS

This application is a continuation application of International Application No. PCT/KR2025/012003 designating the United States, filed on Aug. 8, 2025, in the Korean Intellectual Property Receiving Office and claiming priority to Korean Patent Application No. 10-2024-0108287, filed on Aug. 13, 2024, and Korean Patent Application No. 10-2024-0165129, filed on Nov. 19, 2024, the disclosures of which are all hereby incorporated by reference herein in their entireties.

### BACKGROUND

### Technical Field

Various example embodiments may relate to a fixation member and/or a head mountable display including the same.

### Background Art

Wearable head mountable display devices that can be directly worn on the body are being developed as electronic devices for providing augmented reality (AR) or virtual reality (VR) services. A wearable head mountable display device providing augmented reality or virtual reality services is used in fields such as gaming, education, entertainment, healthcare, and simulation, and can be provided in the form of a headset (head-mountable device, HMD) worn on a user's head.

The information described above may be provided as the related art for the purpose of enhancing the understanding of the present disclosure. No assertion or determination is made with respect to the applicability of any of the above-mentioned as the prior art related to the present disclosure.

### SUMMARY

An electronic device in the form of a headset (e.g., a head mountable display device) worn on a user's head may require length adjustment to fit the circumference of the user's head.

The length adjustment device of the head mountable display device may operate differently when rotated clockwise and counterclockwise due to the shape structure of the gear. As a result, when the user adjusts the length of the head mountable display device, the length may not be fixed in the direction where the length is reduced. Therefore, even after the user wears the head mountable display device, the length may increase regardless of the user's intent, which may cause difficulty for the user in wearing the head mountable display device securely. In addition, the inability to provide a consistent operating form in both directions may degrade the user's feel of operation.

The length adjustment device of the head mountable display device may generate a fastening sound only during one-directional rotation. This may cause unwanted noise when the user adjusts the length, potentially leading to discomfort. In particular, such noise in a quiet environment may disrupt the user's concentration.

Technical problems to be solved by the present disclosure are not limited to the above-mentioned technical problems, and other technical problems, which are not mentioned above, may be clearly understood from the following descriptions by those skilled in the art to which the present disclosure pertains.

A head mountable display device according to an example embodiment may include a wheel, a first plate coupled, directly or indirectly, to the wheel and comprising a first seating groove, a gear having a first surface disposed at, directly or indirectly, the first plate, a second plate disposed at, directly or indirectly, the second surface of the gear, which is an opposite surface of the first surface of the gear, and comprising a plurality of second seating grooves along a circumference, and a fixation member having the first surface and the second surface which is an opposite surface of the first surface, wherein the fixation member comprises a protrusion, at least a portion of the first surface of the fixation member disposed in (entirely or partially) the first seating groove, and at least a portion of the second surface of the fixation member disposed in (entirely or partially) at least one of the plurality of second seating grooves, and a body extending from the protrusion.

A length adjustment device of the head mountable display device may include the same operating form when rotating clockwise and counterclockwise. As a result, a user can experience consistent feel of operation when adjusting the length, making the user's operation more intuitive.

The user can adjust the length of the head mountable display device by applying force to rotate the wheel. Therefore, the user can adjust the length to their desired size either before or after wearing the head mountable display device. In addition, the length can be securely fixed through the fixation member of the head mountable display device, preventing or reducing chances of the length from changing while the user is wearing the head mountable display device.

The noise generated when adjusting the length of the head mountable display device can be reduced, and the user's feel of operation can be improved. The reduction in noise generated when adjusting the length of the head mountable display device makes it easier to use in quiet environments. A smooth feel of operation can be provided to the user.

### BRIEF DESCRIPTION OF DRAWINGS

In connection with the description of the drawings, the same or similar reference numerals may be used for the same or similar constituent elements.

FIG. 1A is a block diagram of a head mountable display device in a network environment according to certain example embodiments.

FIG. 1B is a perspective view of the head mountable display device according to an example embodiment.

FIG. 1C is a front view of a display device of the head mountable display device according to an example embodiment.

FIG. 1D is a rear view of the display device of the head mountable display device according to an example embodiment.

FIG. 2A is an exploded perspective view of a length adjustment device of the head mountable display device according to an example embodiment.

FIG. 2B is a cross-sectional view of the length adjustment device of the head mountable display device in FIG. 2A, according to an example embodiment.

FIG. 2C is a view illustrating a fixation member of the length adjustment device according to an example embodiment.

FIG. 3A is a view illustrating the assembled state of the first plate and fixation member of the length adjustment device according to an example embodiment.

FIG. 3B is a view illustrating the state where a second fixation member of the length adjustment device is detached from the first plate, according to an example embodiment.

FIG. 4A is a front view of the assembled state of the first plate, fixation member, and gear of the length adjustment device according to an example embodiment.

FIG. 4B is a cross-sectional view taken along line 4b-4b illustrated in FIG. 4A.

FIG. 5A is a front view of the assembled state of the gear, fixation member, and second plate of the length adjustment device according to an example embodiment.

FIG. 5B is a cross-sectional view taken along line 5b-5b illustrated in FIG. 5A.

FIG. 5C is a top plan view of FIG. 5A.

FIG. 6A is a view illustrating the assembly of the gear, rubber ring, and second plate of the length adjustment device according to an example embodiment.

FIG. 6B is a top plan view of FIG. 6A.

FIG. 7 is a front view of the assembled state of the wheel and first housing of the length adjustment device, according to an example embodiment.

FIG. 8A is an enlarged front view of the assembled state of the wheel, elastic member, and first housing of the length adjustment device, according to an example embodiment.

FIG. 8B is a cross-sectional view taken along line 8b-8b illustrated in FIG. 8A.

FIG. 9A is an enlarged top plan view of the first housing in FIG. 8A.

FIG. 9B is an enlarged bottom view of the wheel in FIG. 8A.

FIG. 10 is an enlarged front view of the assembled state of the wheel, ball, and first housing of the length adjustment device, according to an example embodiment.

FIG. 11A is an enlarged top plan view of the first housing in FIG. 10.

FIG. 11B is an enlarged bottom view of the wheel in FIG. 10.

### DETAILED DESCRIPTION

In the following description, various embodiments of the disclosure will be described with reference to the accompanying drawings. It should be appreciated that various embodiments of the disclosure and the terms used therein are not intended to limit the technological features set forth herein to particular embodiments and the disclosure includes various changes, equivalents, or alternatives for a corresponding embodiment.

With regard to the description of the drawings, similar reference numerals may be used to designate similar or relevant elements. A singular form of a noun corresponding to an item may include one or more of the items, unless the relevant context clearly indicates otherwise.

As used herein, each of such phrases as “A or B,” “at least one of A and B,” “at least one of A or B,” “A, B, or C,” “at least one of A, B, and C,” and “at least one of A, B, or C” may include all possible combinations of the items enumerated together in a corresponding one of the phrases. Such terms as “a first,” “a second,” “the first,” and “the second” may be used to simply distinguish a corresponding element from another, and does not limit the elements in other aspect (e.g., importance or order). If an element (e.g., a first element) is referred to, with or without the term “operatively” or “communicatively”, as “coupled with/to” or “connected with/to” another element (e.g., a second element), it means that the element may be coupled/connected with/to the other element directly (e.g., wiredly), wirelessly, or via at least a third element(s). Thus, “connected” as used herein covers both direct and indirect connections, as does “coupled.”

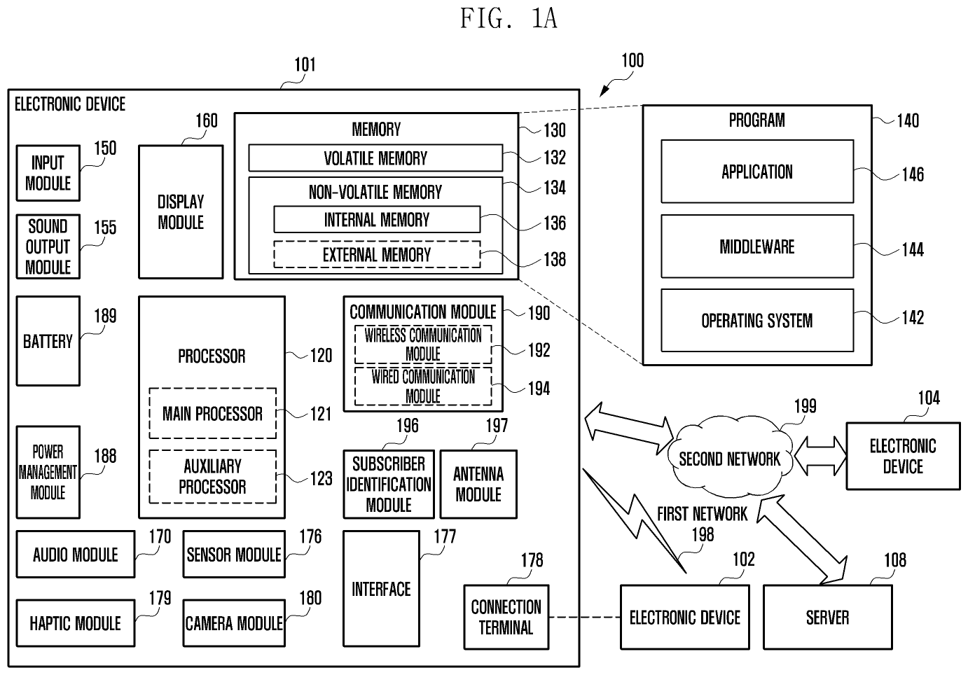

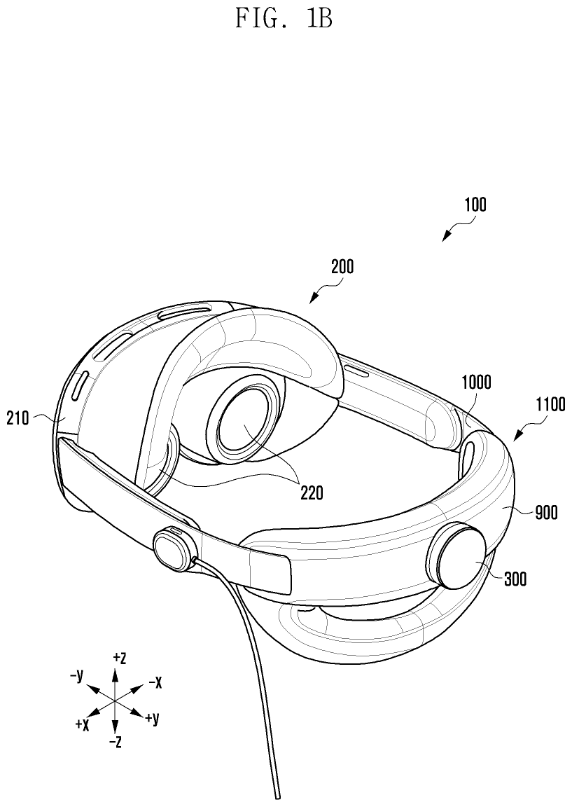

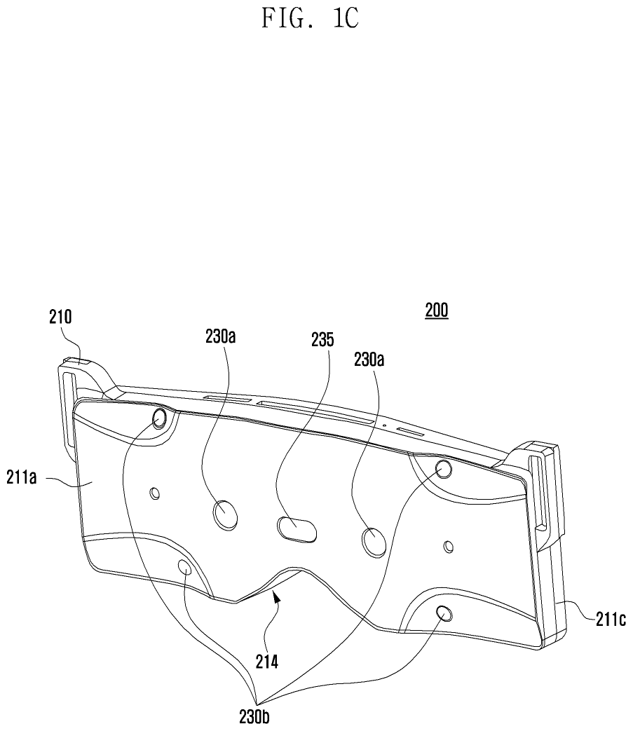

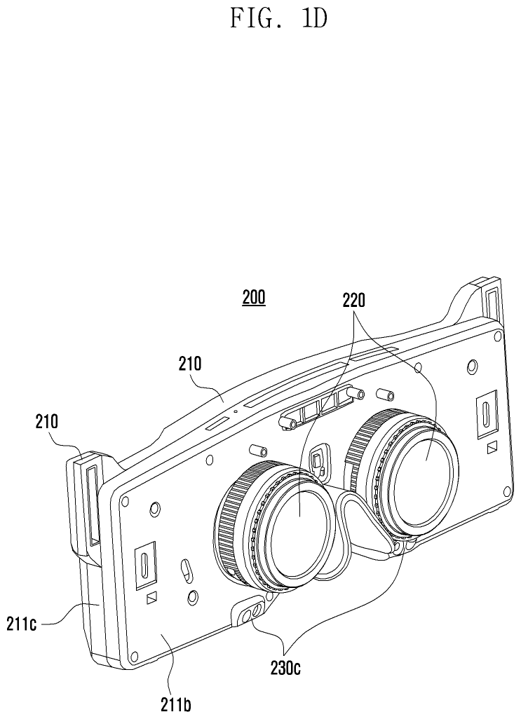

FIG. 1a is a block diagram illustrating a head mountable display device 100 in a network environment according to various embodiments.

Referring to FIG. 1a, the head mountable display device 100 in the network environment may communicate with a head mountable display device 102 via a first network 198 (e.g., a short-range wireless communication network), or at least one of a head mountable display device 104 or a server 108 via a second network 199 (e.g., a long-range wireless communication network).

According to an embodiment, the head mountable display device 100 may communicate with the head mountable display device 104 via the server 108.

According to an embodiment, the head mountable display device 100 may include a processor 120, memory 130, an input circuit 150, a sound output circuit 155, a display circuit 160, an audio circuit 170, a sensor circuit 176, an interface 177, a connecting terminal 178, a haptic circuit 179, a camera 180, a power management circuit 188, a battery 189, a communication circuit 190, a subscriber identification circuit (SIM) 196, or an antenna 197.

According to an embodiment, the processor 120 may include at least one or more processors. The processor 120 may include a processing circuit.

According to an embodiment, at least one of the components (e.g., the connecting terminal 178) may be omitted from the head mountable display device 100, or one or more other components may be added in the head mountable display device 100.

According to an embodiment, some of the components of the head mountable display device 100 (e.g., the sensor module 176, the camera 180, or the antenna 197) may be implemented as a single component (e.g., the display module 160).

According to an embodiment, the processor 120 may execute, for example, software (e.g., a program 140) to control at least one other component (e.g., a hardware or software component) of the head mountable display device 100 coupled with the processor 120, and may perform various data processing or computation.

According to an embodiment, as at least part of the data processing or computation, the processor 120 may store a command or data received from another component (e.g., the sensor 176 or the communication circuit 190) in volatile memory 132, process the command or the data stored in the volatile memory 132, and store resulting data in non-volatile memory 134.

According to an embodiment, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the head mountable display device 100 includes the main processor 121 and the auxiliary processor 123, the auxiliary processor 123 may be adapted to consume less power than the main processor 121, or to be specific to a specified function. The auxiliary processor 123 may be implemented as separate from, or as part of the main processor 121.

According to an embodiment, the auxiliary processor 123 may control at least some of functions or states related to at least one component (e.g., the display module 160, the sensor 176, or the communication circuit 190) among the components of the head mountable display device 100, instead of the main processor 121 while the main processor 121 is in an inactive (e.g., sleep) state, or together with the main processor 121 while the main processor 121 is in an active state (e.g., executing an application).

According to an embodiment, the auxiliary processor 123 (e.g., an image signal processor or a communication processor) may be implemented as part of another component (e.g., the camera 180 or the communication circuit 190) functionally related to the auxiliary processor 123.

According to an embodiment, the auxiliary processor 123 (e.g., the neural processing unit) may include a hardware structure specified for artificial intelligence model processing. An artificial intelligence model may be generated by machine learning. Such learning may be performed, e.g., by the head mountable display device 100 where the artificial intelligence is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

According to an embodiment, the memory 130 may store various data used by at least one component (e.g., the processor 120 or the sensor module 176) of the head mountable display device 100. The various data may include, for example, software (e.g., the program 140) and input data or output data for a command related thereto. The memory 130 may include the volatile memory 132 or the non-volatile memory 134.

According to an embodiment, the program 140 may be stored in the memory 130 as software, and may include, for example, an operating system (OS) 142, middleware 144, or an application 146.

According to an embodiment, the input circuit 150 may receive a command or data to be used by another component (e.g., the processor 120) of the head mountable display device 100, from the outside (e.g., a user) of the head mountable display device 100. The input module 150 may include, for example, a microphone, a mouse, a keyboard, a key (e.g., a button), or a digital pen (e.g., a stylus pen).

According to an embodiment, the sound output module 155 may output sound signals to the outside of the head mountable display device 100. The sound output module 155 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

According to an embodiment, the display module 160 may visually provide information to the outside (e.g., a user) of the head mountable display device 100. The display module 160 may include, for example, a display, a hologram device, or a projector and control circuitry to control a corresponding one of the display, hologram device, and projector.

According to an embodiment, the display module 160 may include a touch sensor adapted to detect a touch, or a pressure sensor adapted to measure the intensity of force incurred by the touch.

According to an embodiment, the audio circuit 170 may convert a sound into an electrical signal and vice versa.

According to an embodiment, the audio circuit 170 may obtain the sound via the input circuit 150, or output the sound via the sound output circuit 155, or through an external head-mountable display device (e.g., head-mountable display device 102) that is directly or wirelessly connected to the head-mountable display device 100 (e.g., speaker, headphones, case, or phone).

According to an embodiment, the sensor 176 may detect an operational state (e.g., power or temperature) of the head mountable display device 100 or an environmental state (e.g., a state of a user) external to the head mountable display device 100, and then generate an electrical signal or data value corresponding to the detected state. According to an embodiment, the sensor 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

According to an embodiment, the sensor 176 may include at least one of an IR (infrared) sensor, an RGB (red, green, blue) sensor, or an image sensor.

According to an embodiment, the interface 177 may support one or more specified protocols to be used for the head mountable display device 100 to be coupled with the external head-mountable display device (e.g., the head mountable display device 102) directly (e.g., wiredly) or wirelessly.

According to an embodiment, the interface 177 may include, for example, a high definition multimedia interface (HDMI), a universal serial bus (USB) interface, a secure digital (SD) card interface, or an audio interface.

According to an embodiment, the head-mountable display device 102 may be the same type or a different type of device as the head-mountable display device 100.

According to an embodiment, the head-mountable display device 102 may include at least some of the components included in the head-mountable display device 100. For example, the head-mountable display device 102 may include a memory, a processor, a battery, or a power management circuit. The memory included in the head-mountable display device 102 may store commands, data, or programs.

According to an embodiment, all or some of the operations executed in the head-mountable display device 100 may be executed in the head-mountable display device 102. For example, when the head-mountable display device 100 needs to perform a certain function or service automatically or in response to a request from a user or another device, instead of or in addition to executing the function or service itself, the head-mountable display device 100 may request one or more external head-mountable display devices (e.g., the head-mountable display device 102) to perform at least a part of the function or service. The one or more external head-mountable display devices (e.g., the head-mountable display device 102) that receive the request may execute at least a part of the requested function or service, or an additional function or service related to the request, and transmit the execution result to the head-mountable display device 100. The head-mountable display device 100 may provide the result as at least part of the response to the request, either as it is or after additional processing. For example, the head-mountable display device 102 may render content data executed in an application and then transmit it to the head-mountable display device 100. The head-mountable display device 100, upon receiving the data, may output the content data to the display 160. If the head-mountable display device 100 detects user movement through an IMU sensor or the like, the processor 120 of the head-mountable display device 100 may correct the rendering data received from the head-mountable display device 102 based on the movement information and output it to the display 160. Alternatively, the head-mountable display device 100 may transmit the movement information to the head-mountable display device 102, requesting rendering updates so that the screen data is refreshed accordingly.

According to an embodiment, the head-mountable display device 102 may be a case device or other types of devices that can store and charge the head-mountable display device 100.

According to an embodiment, A connecting terminal 178 may include a connector via which the head mountable display device 100 may be physically connected with the external head mountable display device (e.g., the head mountable display device 102).

According to an embodiment, the connecting terminal 178 may include, for example, a HDMI connector, a USB connector, a SD card connector, or an audio connector (e.g., a headphone connector).

According to an embodiment, the haptic circuit 179 may convert an electrical signal into a mechanical stimulus (e.g., a vibration or a movement) or electrical stimulus which may be recognized by a user via his tactile sensation or kinesthetic sensation. According to an embodiment, the haptic circuit 179 may include, for example, a motor, a piezoelectric element, or an electric stimulator.

According to an embodiment, the head-mountable display device 100 may include at least one camera 180. For example, the at least one camera 180 included in the head-mountable display device 100 may include a camera that captures real-world images facing outward from the head-mountable display device 100 and a camera that tracks the wearer's eyes of the head-mountable display device 100.

According to an embodiment, the camera 180 may capture a still image or moving images. According to an embodiment, the camera 180 may include one or more lenses, image sensors, image signal processors, or flashes.

According to an embodiment, the power management circuit 188 may manage power supplied to the head mountable display device 100. According to an embodiment, the power management circuit 188 may be implemented as at least part of, for example, a power management integrated circuit (PMIC).

According to an embodiment, the battery 189 may supply power to at least one component of the head mountable display device 100. According to an embodiment, the battery 189 may include, for example, a primary cell which is not rechargeable, a secondary cell which is rechargeable, or a fuel cell.

According to an embodiment, the communication circuit 190 may support establishing a direct (e.g., wired) communication channel or a wireless communication channel between the head mountable display device 100 and the external head mountable display device (e.g., the head mountable display device 102, the head mountable display device 104, or the server 108) and performing communication via the established communication channel. The communication circuit 190 may include one or more communication processors that are operable independently from the processor 120 (e.g., the application processor (AP)) and supports a direct (e.g., wired) communication or a wireless communication.

According to an embodiment, the communication circuit 190 may include a wireless communication circuit 192 (e.g., a cellular communication circuit, a short-range wireless communication circuit, or a global navigation satellite system (GNSS) communication circuit) or a wired communication circuit 194 (e.g., a local area network (LAN) communication circuit or a power line communication (PLC) circuit). A corresponding one of these communication circuits may communicate with the external head mountable display device via the first network 198 (e.g., a short-range communication network, such as Bluetooth™, wireless-fidelity (Wi-Fi) direct, or infrared data association (IrDA)) or the second network 199 (e.g., a long-range communication network, such as a legacy cellular network, a 5G network, a next-generation communication network, the Internet, or a computer network (e.g., LAN or wide area network (WAN)). These various types of communication circuits may be implemented as a single component (e.g., a single chip), or may be implemented as multi components (e.g., multi chips) separate from each other. The wireless communication circuit 192 may identify and authenticate the head mountable display device 100 in a communication network, such as the first network 198 or the second network 199, using subscriber information (e.g., international mobile subscriber identity (IMSI)) stored in the subscriber identification circuit 196.

According to an embodiment, the wireless communication circuit 192 may support a 5G network, after a 4G network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication circuit 192 may support a high-frequency band (e.g., the mmWave band) to achieve, e.g., a high data transmission rate. The wireless communication circuit 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication circuit 192 may support various requirements specified in the head mountable display device 100, an external head mountable display device (e.g., the head mountable display device 104), or a network system (e.g., the second network 199).

According to an embodiment, the wireless communication circuit 192 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC.

The antenna 197 may transmit or receive a signal or power to or from the outside (e.g., the external head mountable display device) of the head mountable display device 100.

According to an embodiment, the antenna 197 may include an antenna including a radiating element composed of a conductive material or a conductive pattern formed in or on a substrate (e.g., a printed circuit board (PCB)).

According to an embodiment, the antenna 197 may include a plurality of antennas (e.g., array antennas). In such a case, at least one antenna appropriate for a communication scheme used in the communication network, such as the first network 198 or the second network 199, may be selected, for example, by the communication circuit 190 (e.g., the wireless communication circuit 192) from the plurality of antennas. The signal or the power may then be transmitted or received between the communication circuit 190 and the external electronic device via the selected at least one antenna.

According to an embodiment, another component (e.g., a radio frequency integrated circuit (RFIC)) other than the radiating element may be additionally formed as part of the antenna 197.

According to various embodiments, the antenna 197 may form a mmWave antenna module.

According to an embodiment, the mmWave antenna may include a printed circuit board, a RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

According to an embodiment, at least some of the above-described components of the head mountable display device 100 may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the head mountable display device 100 and the external head mountable display device 104 via the server 108 coupled with the second network 199. Each of the head mountable display devices 102 or 104 may be a device of a same type as, or a different type, from the head mountable display device 100.

According to an embodiment, all or some of operations to be executed at the head mountable display device 100 may be executed at one or more of the external head mountable display devices 102, 104, or 108. For example, if the head mountable display device 100 should perform a function or a service automatically, or in response to a request from a user or another device, the head mountable display device 100, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the head mountable display device 100. The head mountable display device 100 may provide the outcome, with or without further processing of the outcome, as at least part of a reply to the request. To that end, a cloud computing, distributed computing, mobile edge computing (MEC), or client-server computing technology may be used, for example. The head mountable display device 100 may provide ultra low-latency services using, e.g., distributed computing or mobile edge computing. In another embodiment, the external head mountable display device 104 may include an internet-of-things (IoT) device. The server 108 may be an intelligent server using machine learning and/or a neural network.

According to an embodiment, the external head mountable display device 104 or the server 108 may be included in the second network 199. The head mountable display device 100 may be applied to intelligent services (e.g., smart home, smart city, smart car, or healthcare) based on 5G communication technology or IoT-related technology.

FIG. 1B is a perspective view of the head mountable display device according to an example embodiment.

In an embodiment, the head mountable display device 100 may, for example, be a head mountable display (HMD), a face mountable display (FMD), or a smart glass or headset providing extended reality such as augmented reality (AR), virtual reality (VR), or mixed reality, and is not limited thereto.

With reference to FIG. 1A to FIG. 1B, the head mountable display device 100 may be worn on a part of the user's body (e.g., head or face) to provide a user interface.

In an embodiment, the head mountable display device 100 may output photos and/or images to the user. Alternatively, the head mountable display device 100 may provide images related to augmented reality services and/or virtual reality services. For example, the head mountable display device 100 may provide the user with experiences of augmented reality, virtual reality, mixed reality, and/or extended reality.

For example, the head mountable display device 100 may provide the user with augmented reality. The head mountable display device 100 may transmit the virtual object image output from the display 160 toward the user's eyes, and the virtual object image may use data of images of the real world captured through a plurality of cameras 230a, 230b, and 230c.

In an embodiment, the head mountable display device 100 may include a length adjustment function to enhance the user's feel of wearing. For example, a first housing 900 of the head mountable display device 100 (e.g., first band, first length adjustment device, back band) and/or a second housing 1000 (e.g., second band, second length adjustment device, side band) may be adjusted in length through a wheel 300 (e.g., handle, rotating device, cap) on a part of the user's body (e.g., head).

In an embodiment, with reference to FIG. 1B, a lens housing 210, the first housing 900, and the second housing 1000 may form the side surface of the head mountable display device 100. The configuration of the head mountable display device 100 described above is an example, and the head mountable display device 100 may omit at least one of the configurations described above or include at least one additional configuration.

FIG. 1C is a front view of a display device of the head mountable display device according to an example embodiment. FIG. 1D is a rear view of the display device of the head mountable display device according to an example embodiment.

In an embodiment, with reference to FIG. 1A to FIG. 1D, the head mountable display device 100 may include a display device 200 that outputs photos and/or images to the user.

In an embodiment, some of the constituent elements of the head mountable display device 100 in FIG. 1A may include the display device 200 in FIG. 1C and FIG. 1D.

In an embodiment, the display device 200 may include at least a part of the lens housing 210, the plurality of cameras 230a, 230b, and 230c, and the display 160.

In an embodiment, the display device 200 may include the lens housing 210. The lens housing 210 may be configured to accommodate at least one component. The lens housing 210 may include a first surface 211a (e.g., front surface), a second surface 211b (e.g., rear surface or wearing surface) opposite the first surface 211a, and a third surface 211c (e.g., side surface) between the first surface 211a and the second surface 211b.

In an embodiment, the lens housing 210 may include a bridge 214. The bridge 214 may be configured to face a part of the user's body (e.g., nose). For example, the bridge 214 may be supported by the user's nose.

In an embodiment, the lens housing 210 may correspond to the main body of the display device 200. The lens housing 210 may be the same as the main body of the display device 200.

In an embodiment, the lens housing 210 may be mountable on the user's head by a wearing structure such as a template or strap.

In an embodiment, the display device 200 may include a lens structure 220. The lens structure 220 may include a plurality of lenses configured to adjust the focus of the images provided to the user. For example, the plurality of lenses may be configured to adjust the focus of the images output by the display 160. The plurality of lenses may be disposed at positions corresponding to the position of the display 160. The plurality of lenses may include, for example, Fresnel lenses, pancake lenses, multi-channel lenses, and/or any other suitable lenses.

In an embodiment, the display 160 may be disposed at a position corresponding to the lens structure 220.

In an embodiment, the display device 200 may include the display 160. The display 160 may be configured to provide images (e.g., virtual images) to the user. For example, the display 160 may include a liquid crystal display (LCD), a digital mirror device (DMD), a liquid crystal on silicon (LCoS), an organic light emitting diode (OLED), and/or a micro light emitting diode (micro LED).

In an embodiment, when the display 160 includes at least one of a liquid crystal display, a digital mirror device, or a liquid crystal on silicon, the display device 200 may include a light source that irradiates light to the screen output area of the display 160.

In an embodiment, when the display 160 can generate light by itself, for example, when the display 160 includes at least one of an organic light emitting diode or a micro LED, the display device 200 may provide high-quality virtual images to the user without the need for a separate light source.

In an embodiment, when the display 160 includes an organic light emitting diode or a micro LED, a light source is unnecessary, which allows the display device 200 to be lightweight. The display device 200 may include the display 160 and at least one transparent member. The user may use the display device 200 while wearing it on the face. At least one transparent member may be formed of a glass plate, plastic plate, or polymer, and may be made transparent or semi-transparent.

In an embodiment, at least one transparent member may be disposed to face the user's right eye or left eye.

In an embodiment, when the display 160 is transparent, it may be disposed at a position facing the user's eyes to form a screen display unit. In an embodiment, the display 160 may include a light source (not illustrated) configured to transmit optical signals to the area where the image is output.

In an embodiment, the display 160 may provide images to the user by generating optical signals on its own.

In an embodiment, the display 160 may be disposed on the second surface 211b of the lens housing 210. For example, the first surface of a pair of lenses of the display 160 may be positioned to be exposed to the outside through the second surface 211b.

In an embodiment, the display 160 may be composed of organic light emitting diodes (OLEDs). For example, OLEDs may represent red (R), green (G), and blue (B) through the self-emission of organic materials. However, this is not limited thereto, and one pixel may include R, G, and B, and one chip may be implemented with a plurality of pixels that include R, G, and B.

In an embodiment, the display 160 may display various images. Here, the term “image” refers to both still images and moving images, and the display 160 may display various images such as broadcast content, multimedia content, and the like. Additionally, the display 160 may display a user interface (UI) and icons.

In an embodiment, the display 160 may include a separate IC chip, and the IC chip may display an image based on the image signal received from the processor 120. In an embodiment, the IC chip may generate driving signals for a plurality of light-emitting elements based on the image signal received from the processor 120, and display an image by controlling the emission of the plurality of pixels included in the display panel based on the driving signals.

In an embodiment, the display 160 may include a plurality of pixels to display a virtual image. The display 160 may further include infrared pixels that emit infrared light.

In an embodiment, the display 160 may further include photoreceptive pixels (e.g., photo sensor pixels) disposed between the pixels, which capture light reflected from the user's eyes and convert it into electrical energy for output. The photoreceptive pixels may be referred to as a “gaze tracking sensor.” The gaze tracking sensor may sense infrared light reflected by the user's eyes, which is emitted by the infrared pixels included in the display 160.

In an embodiment, the display device 200 may detect the user's gaze direction (e.g., eyeball movement) through the photoreceptive pixels.

In an embodiment, the display device 200 may determine the position of the center of the virtual image based on the gaze direction of the user's left eye and right eye (e.g., direction in which the user's left eye and right eye's eyeballs are gazing), which is detected through one or more photoreceptive pixels.

In an embodiment, the display device 200 may include at least one display. The display device 200 may include the display 160 as the main display and include a 3D display as an auxiliary display or external display.

In an embodiment, the display 160 may include a condensing lens and/or a transparent waveguide. For example, the transparent waveguide may be positioned at least partially in a part of the glass.

In an embodiment, the light emitted from the display 160 may be incident on one end of the glass, and the incident light may be transmitted to the user through a waveguide formed within the glass. The waveguide may be made of glass, plastic, or polymer, and may include a nano pattern formed on the first surface inside or outside the waveguide, for example, a grating structure with a polygonal or curved shape.

In an embodiment, the incident light may propagate or reflect inside the waveguide due to a nano pattern and be provided to the user.

In an embodiment, the waveguide may include at least one of at least one diffractive element (e.g., a diffractive optical element (DOE) or a holographic optical element (HOE)) or a reflective element (e.g., a reflective mirror).

In an embodiment, the waveguide may use at least one diffractive element or reflective element to guide the display light emitted from the light source unit toward the user's eyes.

In an embodiment, the waveguide serves to transmit the light source generated by the display to the user's eyes.

In an embodiment, the waveguide may be made of glass, plastic, or polymer, and may include a nano pattern formed on an internal or external partial surface of the waveguide, for example, a grating structure with a polygonal or curved shape.

In an embodiment, the light incident on one end of the waveguide may propagate inside the display 160 light waveguide due to the nano pattern and be provided to the user. Additionally, a light waveguide composed of a free-form prism may reflect the incident light through a reflective mirror and provide it to the user. The light waveguide may include at least one of at least one diffractive element (e.g., a diffractive optical element (DOE) or a holographic optical element (HOE)) or a reflective element (e.g., a reflective mirror). The light waveguide may use at least one diffractive element or reflective element included in the light waveguide to guide the display light emitted from the light source unit to the user's eyes.

In an embodiment, the diffractive element may include an input optical member/output optical member (not illustrated). For example, the input optical member may refer to an input grating area, and the output optical member (not illustrated) may refer to an output grating area. The input grating area may serve as an input stage that diffracts (or reflects) the light emitted from (e.g., Micro LED), directing it to the transparent members (e.g., first transparent member, the second transparent member) of the screen display unit. The output grating area may serve as an exit that diffracts (or reflects) the light transmitted to the transparent members (e.g., first transparent member, the second transparent member) of the waveguide toward the user's eyes.

In an embodiment, the reflective element may include a total internal reflection optical component or a total internal reflection waveguide for total internal reflection (TIR). For example, the total internal reflection is a method of guiding light, where the incident angle is set such that the light (e.g., virtual image) entering through the input grating area is 100% reflected from the first surface (e.g., a specific surface) of the waveguide and is transmitted 100% to the output grating area.

In an embodiment, the light emitted from the display 160 may have its optical path guided into the waveguide through the input optical member. The light traveling inside the waveguide may be guided in a direction toward the user's eyes through the output optical member. The screen display unit may be determined based on the light emitted toward the user's eyes.

In an embodiment, the display device 200 may include the sensor 176. The sensor 176 may be configured to sense the depth of a subject. The sensor 176 may be configured to transmit signals toward the subject and/or receive signals from the subject. For example, the transmitted signal may include near-infrared, ultrasound, and/or laser. The sensor 176 may be configured to measure the time of flight (ToF) of the signal to measure the distance between the display device 200 and the subject. The sensor 176 may be disposed on the first surface 211a of the lens housing 210.

In an embodiment, the sensor 176 may include a depth sensor. The depth sensor may be used for the purpose of determining the distance to an object. The depth sensor (e.g., depth sensor 235 in FIG. 1C) may include time of flight (ToF) technology. ToF technology may include a technology for measuring the distance to an object using signals (near-infrared, ultrasound, laser, etc.). ToF technology may involve emitting a signal from a transmission unit and measuring the signal at a reception unit, where the time of flight of the signal is measured.

In an embodiment, the camera 180 in FIG. 1A may include the plurality of cameras 230a, 230b, and 230c.

In an embodiment, the plurality of cameras 230a, 230b, and 230c may include at least some of the first camera 230a, the second camera 230b, or the third camera 230c. The plurality of cameras 230a, 230b, and 230c may capture the outside of the lens housing 210, for example, the user and/or another subject. For example, the plurality of cameras 230a, 230b, and 230c may convert optical signals into input data and provide them to the processor 120. In an embodiment, the processor 120 may receive the transmitted input data and transmit the output data to the display 160. The processor 120 may combine the data received from each of the plurality of cameras 230a, 230b, and 230c, process the combined data, and control the display 160.

In an embodiment, the first camera 230a, which includes at least one camera for capturing, and the second camera 230b, which includes at least one camera for recognition, are disposed at a distance on the first surface 211a of the lens housing 210, to capture the direction in which the first surface 211a of the lens housing 210 faces.

In an embodiment, the camera 180 in FIG. 1A may include at least some of the first camera 230a, the second camera 230b, or the third camera 230c.

In an embodiment, the first camera 230a and the second camera 230b may be disposed at a distance from each other on the first surface 211a of the lens housing 210. The first camera 230a and the second camera 230b may be positioned to face different directions from each other in order to capture various directions, such as the first surface 211a or the third surface 211c.

In an embodiment, the first camera 230a may be configured to obtain images from a subject. The first camera 230a may be formed in plurality, and any one first camera 230a of the plurality of first cameras 230a may be disposed in a partial area of the first surface 211a of the lens housing 210, while another first camera 230a may be disposed in a different area of the lens housing 210 than the partial area of the first surface 211a.

In an embodiment, the plurality of first cameras 230a may be disposed on both sides of the depth sensor 235, respectively. The plurality of first cameras 230a may include an image stabilizer actuator (not illustrated) and/or an autofocus actuator (not illustrated). For example, the plurality of first cameras 230a may include at least one camera of a camera configured to obtain color images, a global shutter camera, or a rolling shutter camera, or a combination thereof.

In an embodiment, the second camera 230b may be configured to recognize a subject. The second camera 230b may be formed in plurality, and the plurality of second cameras 230b may be configured to detect and/or track objects (e.g., head or hands of a human body) or spaces in 3 degrees of freedom or 6 degrees of freedom. For example, the plurality of second cameras 230b may include global shutter cameras. The plurality of second cameras 230b may be configured to perform simultaneous localization and mapping (SLAM) using depth information of the subject. The plurality of second cameras 230b may be configured to recognize the gestures of the subject.

In an embodiment, the plurality of second cameras 230b may be disposed on the first surface 211a of the lens housing 210. “Disposed on” as used herein covers both directly and indirectly on.

In an embodiment, the first camera 230a and the second camera 230b may be cameras for capturing, referred to as high resolution (HR) or photo video (PV), and may include high-resolution cameras. The first camera 230a and the second camera 230b may include color cameras equipped with functions such as auto focus (AF) and optical image stabilizer (OIS) to obtain high-quality images. This is not limited thereto, and the first camera 230a and the second camera 230b may include a global shutter (GS) camera or a rolling shutter (RS) camera.

In an embodiment, the display device 200 may include a plurality of third cameras 230c. The plurality of third cameras 230c may be configured to recognize the user's face. For example, the plurality of third cameras 230c may be configured to detect and track the user's facial expressions.

In an embodiment, the third camera 230c may include at least one facial recognition camera or at least one gaze tracking camera.

In an embodiment, the display device 200 may further include a gaze tracking camera in at least some of the plurality of third cameras 230c. The gaze tracking camera may be used for the purpose of detecting and tracking the eyeball.

In an embodiment, the third camera 230c may detect and track the eyeball. The third camera 230c may include a plurality of cameras corresponding to the left eye and right eye.

In an embodiment, at least one of the plurality of cameras 230a, 230b, and 230c may include a camera used for head tracking of 3 degrees of freedom (DoF) and 6 degrees of freedom (DoF), hand detection and tracking, gesture recognition, and/or spatial recognition.

In an embodiment, at least one of the plurality of cameras 230a, 230b, and 230c may include a global shutter (GS) camera to detect and track the movements of the head and hands. For example, stereo cameras may be used for head tracking and spatial recognition, so two global shutter (GS) cameras with the same specifications and performance may be used. Additionally, for detecting and tracking fast hand movements and subtle motions such as finger movements, rolling shutter (RS) cameras may be used.

In an embodiment, at least one of the plurality of cameras 230a, 230b, and 230c may primarily use a global shutter (GS) camera, which has superior performance compared to other cameras (e.g., image drag). However, this is not limited thereto, and, for example, a rolling shutter (RS) camera may also be used. At least one of the plurality of cameras 230a, 230b, and 230c may perform simultaneous localization and mapping (SLAM) functions for spatial recognition and depth capturing to enable 6 degrees of freedom (DoF). At least one of the plurality of cameras 230a, 230b, and 230c may perform a user gesture recognition function.

In an embodiment, the display device 200 may include an inertial measurement unit (IMU) sensor. The IMU sensor may include at least one of an accelerometer, a gyroscope, or a magnetometer. The display device 200 may sense the user's movements based on the IMU sensor.

In an embodiment, although not illustrated in the drawings, the display device 200 may include at least some of a sensor (not illustrated), a lighting unit (not illustrated), a plurality of microphones (not illustrated), a plurality of speakers (not illustrated), a battery (not illustrated), or a printed circuit board (not illustrated).

In an embodiment, the sensor (not illustrated) may exist as one or more for various purposes (e.g., gyroscope sensor, accelerometer sensor, magnetometer sensor, and/or gesture sensor). For example, the sensor (not illustrated) may perform at least one of functions of head tracking for 6 degrees of freedom (DoF), pose estimation and prediction, gesture and/or spatial recognition, and/or SLAM through depth capturing.

In an embodiment, the lighting unit (not illustrated) may have various uses depending on its attachment position. For example, the lighting unit (not illustrated) may be attached around the second surface 211b of the display device 200. The lighting unit (not illustrated) may be used as an auxiliary means to facilitate eye gaze detection when the gaze tracking camera (not illustrated) captures the pupil. The lighting unit (not illustrated) may use an infra-red light emitting device (IR LED) with visible light wavelengths or infrared wavelengths.

For example, the lighting unit (not illustrated) may be attached to the front surface 211a of the display device 200 or surroundings thereof. The lighting unit (not illustrated) may be used as a means to supplement the ambient brightness when the plurality of front surface cameras 230a, 230b capture images. The lighting unit (not illustrated) may be used, especially in dark environments or when detecting the subject to be captured is difficult due to the mixing of multiple light sources and reflected light.

In an embodiment, the lighting unit (not illustrated) may be omitted. The lighting unit (not illustrated) may be replaced by the infrared pixels included in the display 160. The lighting unit (not illustrated) may be included in the display device 200 to assist the infrared pixels included in the display 160.

In an embodiment, the plurality of microphones (not illustrated) may process external sound signals into electrical audio data. The processed audio data may be used in various ways depending on the functions being performed (or the applications running) on the display device 200.

In an embodiment, the plurality of speakers (not illustrated) may output audio data received from the communication circuit or stored in the memory 120.

In an embodiment, one or more batteries (not illustrated) may be included in the display device 200 and supply power to the constituent elements that make up the display device 200.

In an embodiment, the printed circuit board (not illustrated) may transmit electrical signals to each circuit (e.g., camera, display, audio, or sensor) and other printed circuit boards through a flexible printed circuit board (FPCB).

In an embodiment, the printed circuit board (not illustrated) may have a control circuit (not illustrated) positioned thereon that controls the constituent elements that make up the display device 200.

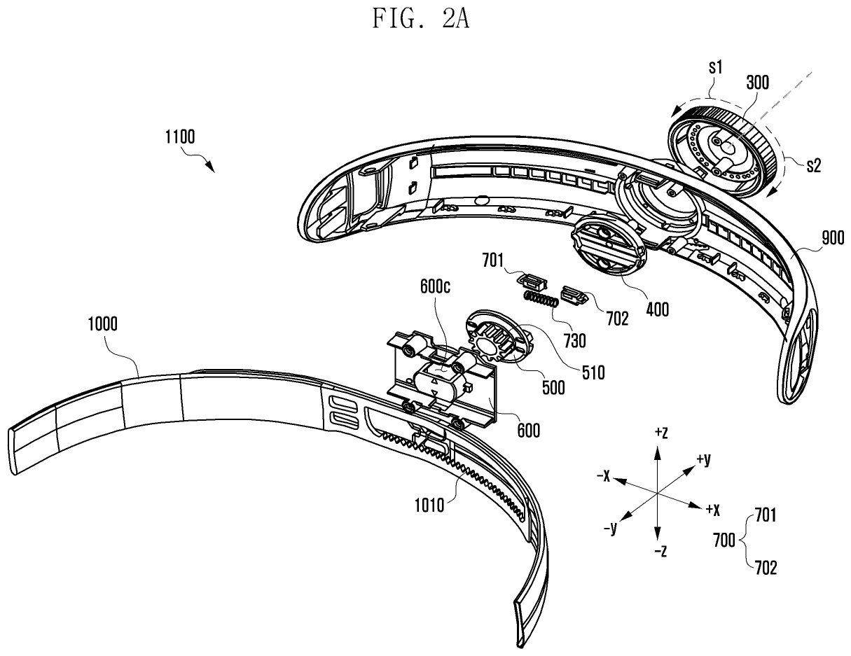

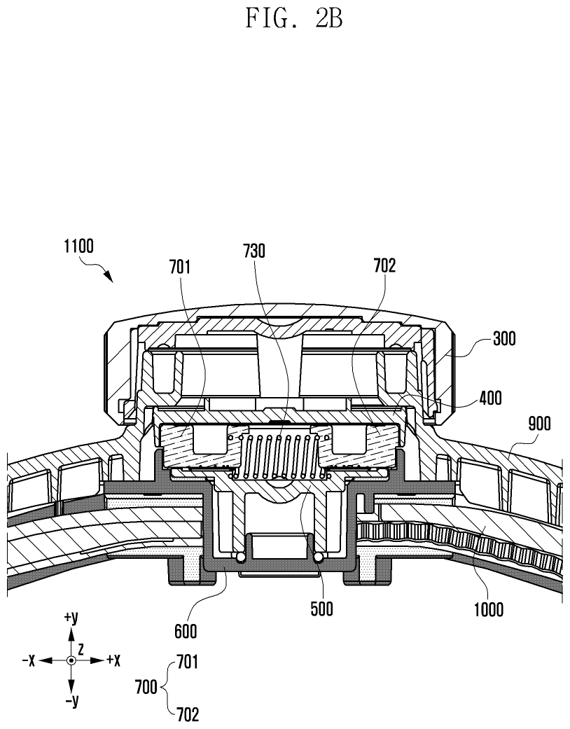

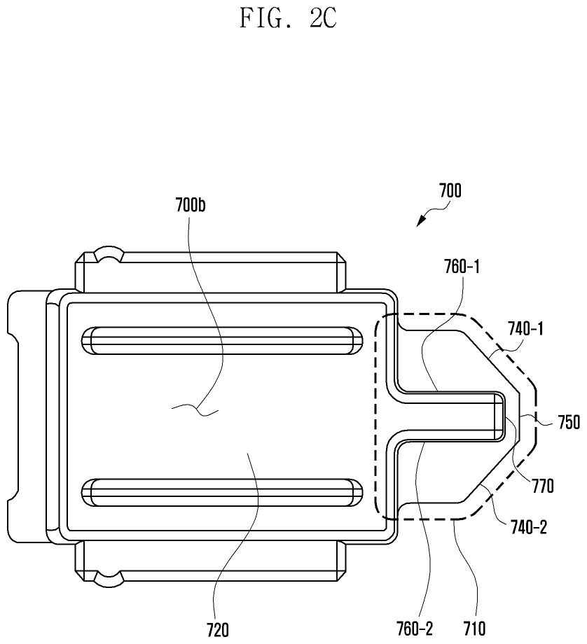

FIG. 2A is an exploded perspective view of a length adjustment device 1100 of the head mountable display device 100 according to an example embodiment. FIG. 2B is a cross-sectional view of the length adjustment device 1100 of the head mountable display device 100 in FIG. 2A, according to an example embodiment. FIG. 2C is a view illustrating a fixation member of the length adjustment device 1100 according to an example embodiment.

In an embodiment, with reference to FIG. 1A to FIG. 2B, the head mountable display device 100 may include the length adjustment device 1100 that allows the length to be adjusted to correspond to a part of the user's body (e.g., head or face).

In an embodiment, the length adjustment device 1100 in FIG. 2A and FIG. 2B may refer to the head mountable display device 100 in FIG. 1A. In an embodiment, some of the constituent elements of the head mountable display device 100 in FIG. 1A may include the length adjustment device 1100 in FIG. 2A and FIG. 2B.

In an embodiment, with reference to FIG. 2A and FIG. 2B, the length adjustment device 1100 may include the wheel 300 (e.g., a handle, rotating device, or cap), a first plate 400 (e.g., a link), a fixation member 700 (e.g., a locker), a gear 500, a second plate 600 (e.g., a holder), a first housing 900 (e.g., first band, first length adjustment device, or back band), and/or a second housing 1000 (e.g., second band, second length adjustment device, or side band).

In an embodiment, the wheel 300 may refer to the part of the length adjustment device 1100 that is operated by the user. For example, the user may rotate the wheel 300 to adjust the length of the second housing 1000.

In an embodiment, the fixation member 700 (e.g., a locker) may be disposed on at least a part of the first plate 400 and second plate 600, and by adjusting the rotation of the gear 500, the length of the second housing 1000 may be adjusted. For example, when the user rotates the wheel 300, causing the first plate 400 to rotate around the rotation axis (e.g., y-axis in FIG. 2B) in a first direction (S1) by a predetermined angle (e.g., 4 degrees in the first direction (S1) based on the y-axis in FIG. 2A), at least a part of the fixation member 700 may be detached from at least a part of the first plate 400 and the second plate 600. For example, when the user releases the wheel 300, at least a part of the fixation member 700 may be re-disposed on at least a part of the first plate 400 and second plate 600 through a spring 730 disposed between a first fixation member 701 and a second fixation member 702.

In an embodiment, at least a part of the fixation member 700 may be disposed on at least a part of the first plate 400 (e.g., a link), and by adjusting the rotation of the gear 500, the length of the second housing 1000 may be adjusted. In an embodiment, when the wheel 300 rotates in the first direction (S1) or a second direction (S2) around the rotation axis (e.g., y-axis in FIG. 2A), the first plate 400 may rotate by the same angle as the rotation angle of the wheel 300 in the same direction as the wheel 300 (e.g., wheel 300 in FIG. 2A). The first plate 400 and the gear 500 may have a rotational lag of a predetermined angle (e.g., 4 degrees in the first direction (S1) based on the y-axis in FIG. 2A). For example, when the user rotates the wheel 300, causing the first plate 400 to rotate around the rotation axis (e.g., y-axis in FIG. 2A) in the first direction (S1), the gear 500 may rotate in the first direction (S1) by the same angle as the rotation angle of the first plate 400 (e.g., first plate 400 in FIG. 2A) after the first plate 400 deviates by a predetermined angle (e.g., 4 degrees in the first direction (S1) based on the y-axis in FIG. 2A).

In an embodiment, at least a part of the fixation member 700 may be disposed on at least a part of the second plate 600 (e.g., a holder), and by adjusting the rotation of the gear 500, the length of the second housing 1000 may be adjusted. For example, when the user rotates the wheel 300, causing the first plate 400 to rotate around the rotation axis (e.g., y-axis in FIG. 2B) in the first direction (S1) by a predetermined angle (e.g., 4 degrees in the first direction (S1) based on the y-axis in FIG. 2A), at least a part of the fixation member 700 may be detached from at least a part of the first plate 400 and the second plate 600, allowing the gear 500 to rotate around the rotation axis. For example, when the user releases the wheel 300, at least a part of the fixation member 700 may be re-disposed on at least a part of the first plate 400 and the second plate 600 through the spring 730 disposed between the first fixation member 701 and the second fixation member 702, preventing or reducing the rotation of the gear 500. In an embodiment, the second plate 600 may include an internal space 600c where at least a part of the gear 500 is inserted. The internal space 600c of the second plate 600, facing the z-axis in FIG. 2A, may be formed to be open.

In an embodiment, the second housing 1000 (e.g., side band) may have its length adjusted to fit the size of a part of the user's body (e.g., head). The second housing 1000 may include a toothed structure 1010 corresponding to the teeth 510 of the gear 500. For example, when the gear 500 rotates due to the rotation of the wheel 300 and the first plate 400, the teeth 510 of the gear 500 engage with the toothed structure 1010 of the second housing 1000 through the open internal space 600c of the second plate 600, allowing the length of the second housing 1000 to be adjusted.

In an embodiment, the first housing 900 (e.g., back band) may be disposed to surround the rear surface (e.g., surface facing the +y-axis in FIG. 2A) of the head mountable display device (e.g., head mountable display device 100 in FIG. 2A). The wheel 300 may be disposed on at least a part of the first surface (e.g., surface facing the +y-axis in FIG. 2A) of the first housing 900, and the second surface (e.g., surface facing the −y-axis in FIG. 2A) of the first housing 900 may be disposed to surround the second housing 1000.

In an embodiment, with reference to FIG. 2A, the rotation in the first direction (S1) around the rotation axis (e.g., y-axis in FIG. 2A) of the wheel 300 (e.g., wheel 300 in FIG. 2A), first plate 400, and second plate 600 may be a rotation in the clockwise direction. The rotation in the second direction (S2) around the rotation axis (e.g., y-axis in FIG. 2A) of the wheel 300 (e.g., wheel 300 in FIG. 2A), first plate 400, and second plate 600 may be a rotation in the counterclockwise direction.

In an embodiment, the wheel 300 and the first plate 400 may be coupled by a screw (not illustrated).

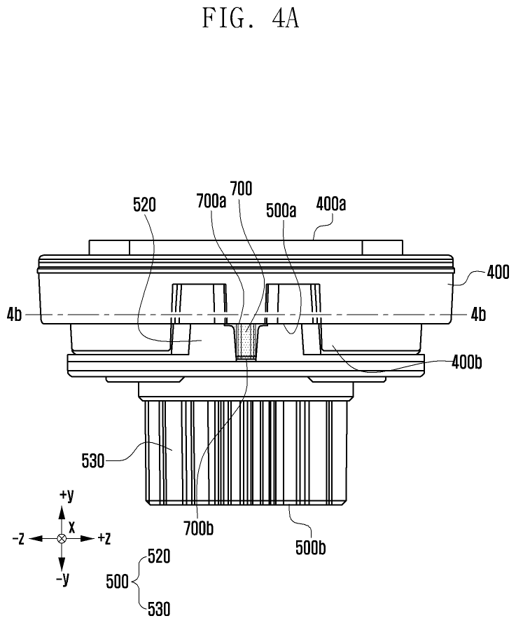

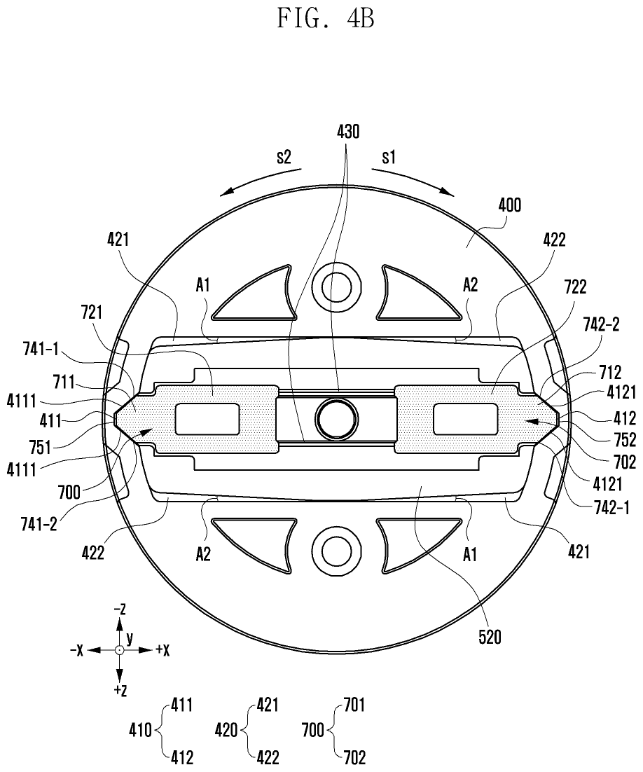

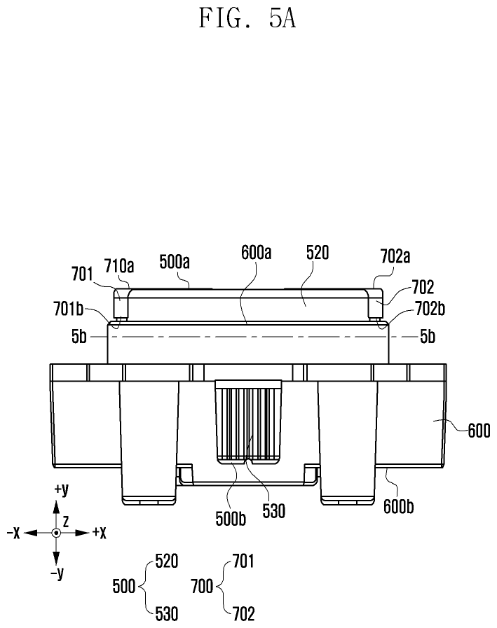

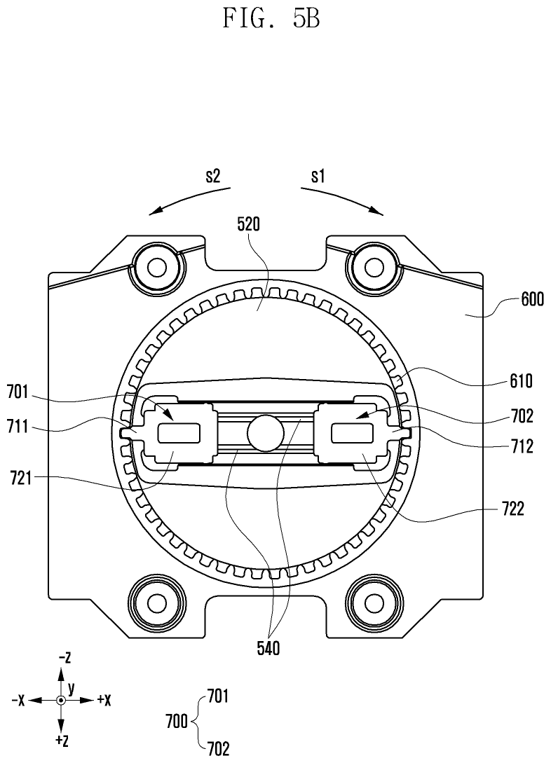

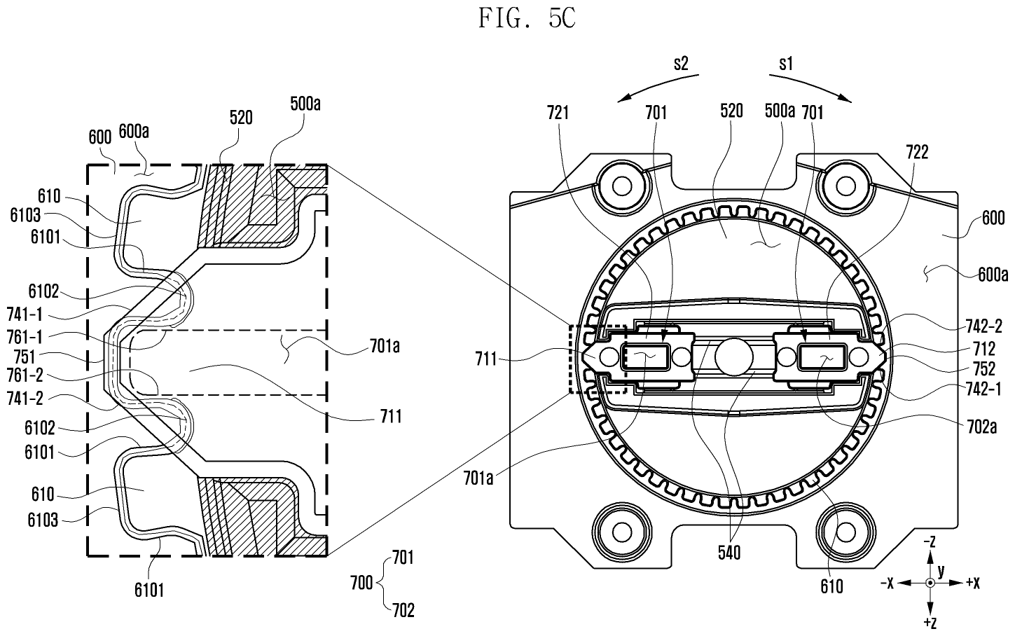

In an embodiment, with reference to FIG. 2A, FIG. 2B, and the later described FIG. 4A, FIG. 4B, FIG. 5A, and FIG. 5B, the first plate 400, fixation member 700, gear 500, and/or second plate 600 may be coupled by fitting.

In an embodiment, with reference to FIG. 2A, FIG. 2B, and FIG. 2C, the fixation member 700 may include the first fixation member 701 and second fixation member 702. The second fixation member 702 may be formed to be symmetrical to the shape of the first fixation member 701 with respect to the rotation axis in the wheel 300 (e.g., y-axis in FIG. 2A).

In an embodiment, with reference to FIG. 2A and the later described FIG. 5A, the fixation member 700 may include a first surface 700a (e.g., surface facing the +y-axis in FIG. 2A) and the a second surface 700b (e.g., surface facing the −y-axis in FIG. 2A), which is an opposite surface of the first surface 700a. The first fixation member 701 may include a first surface 701a and the a second surface 701b, which is an opposite surface of the first surface 701a. The second fixation member 702 may include a first surface 702a and the a second surface 702b, which is an opposite surface of the first surface 702a.

In an embodiment, with reference to FIG. 2A and the later described FIG. 4A, the first surface 700a of the fixation member 700 (e.g., surface facing the +y-axis in FIG. 2A) may be disposed on the second surface 400b of the first plate 400 (e.g., surface facing the −y-axis in FIG. 2A).

In an embodiment, with reference to FIG. 2A and the later described FIG. 5A, the second surface 700b of the fixation member 700 (e.g., surface facing the −y-axis in FIG. 2A) may be disposed on a first surface 600a of the second plate 600 (e.g., surface facing the +y-axis in FIG. 2A).

In an embodiment, with reference to FIG. 2A and FIG. 2B, the first fixation member 701 and the second fixation member 702 may be connected by the spring 730.

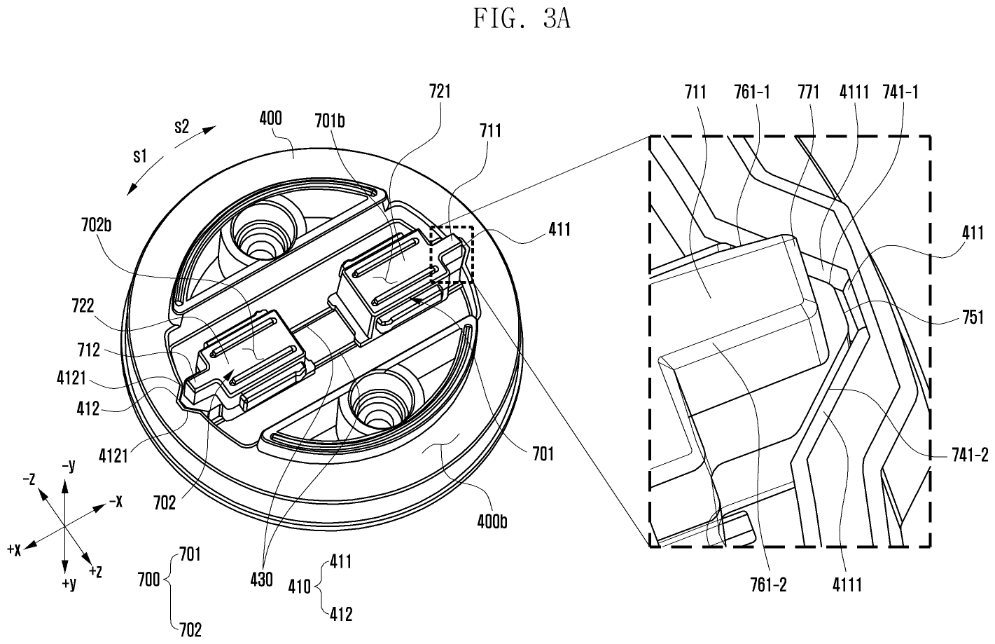

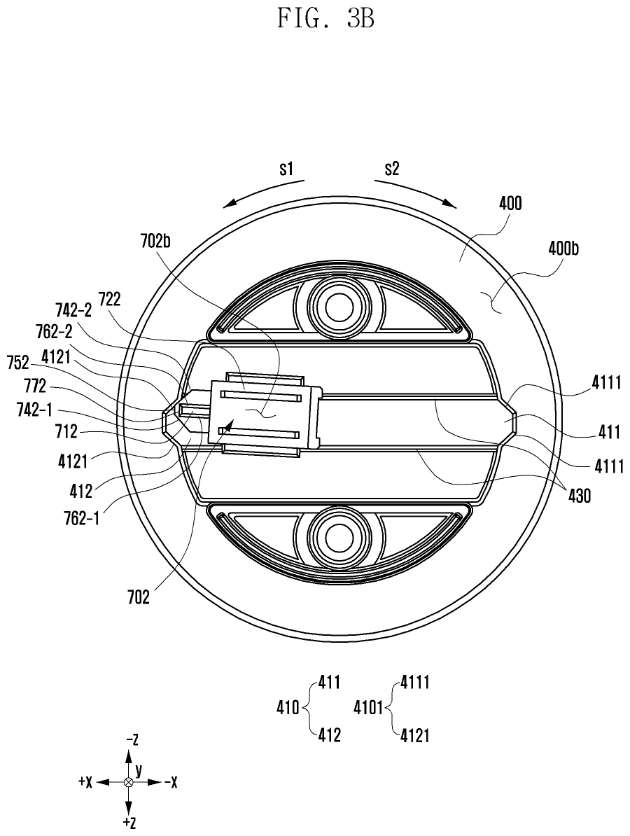

In an embodiment, with reference to FIG. 2A, FIG. 2B, and the later described FIG. 3A and FIG. 5C, the first fixation member 701 and the second fixation member 702 may move in a straight line along a first guide 430 of the first plate 400 through the spring 730. The first fixation member 701 and the second fixation member 702 may move in a straight line along a second guide 540 of the gear 500 through the spring 730. The first guide 430 and the second guide 540 may be disposed in a substantially parallel direction (e.g., x-axis direction in FIG. 2A). Each of the first guide 430 and the second guide 540 may have the first surface 700a of the fixation member 700 (e.g., surface facing the +y-axis in FIG. 2A) and the second surface 700b of the fixation member 700 (e.g., surface facing the −y-axis in FIG. 2A) disposed thereon.

In an embodiment, with reference to FIG. 2C, the fixation member 700 may include a protrusion 710 and a body 720. The body 720 may extend from the protrusion 710. In the following description, although the fixation member 700 is explained as being divided into the protrusion 710 and body 720, it is possible that the fixation member 700 is not physically separated. The protrusion 710 and body 720 may be conceptually separated for the convenience of describing the fixation member 700.

In an embodiment, with reference to FIG. 2C and the later described FIG. 3A, the first fixation member 701 may include a first protrusion 711 and a first body 721. The first body 721 may extend from the first protrusion 711.

In an embodiment, with reference to FIG. 2C and the later described FIG. 3A, the second fixation member 702 may include a second protrusion 712 and a second body 722. The second body 722 may extend from the second protrusion 712.

In an embodiment, with reference to FIG. 2C, the protrusion 710 may include a first-first side surface 740-1, a first-second side surface 740-2, a second side surface 750, a third-first side surface 760-1, a third-second side surface 760-2, and a fourth side surface 770.

In an embodiment, with reference to FIG. 2C and the later described FIG. 3B and FIG. 5C, the first protrusion 711 of the first fixation member 701 may include a first-first side surface 741-1, a first-second side surface 741-2, a second side surface 751, a third-first side surface 761-1, a third-second side surface 761-2, and a fourth side surface 771. The first protrusion 712 of the second fixation member 702 may include a first-first side surface 742-1, a first-second side surface 742-2, a second side surface 752, a third-first side surface 762-1, a third-second side surface 762-2, and a fourth side surface 772.

In an embodiment, with reference to FIG. 2A, FIG. 2C, and the later described FIG. 3B and FIG. 5C, the first-first side surface 740-1, the first-second side surface 740-2, and the second side surface 750 of the protrusion 710 may be formed on the first surface 700a (e.g., surface facing the +y-axis in FIG. 2A) of the fixation member 700. The first-first side surface 741-1, the first-second side surface 741-2, and the second side surface 751 of the first protrusion 711 may be formed on the first surface 701a (e.g., surface facing the +y-axis in FIG. 2A) of the first fixation member 701. The first-first side surface 742-1, the first-second side surface 742-2, and the second side surface 752 of the second protrusion 712 may be formed on the first surface 702a (e.g., surface facing the +y-axis in FIG. 2A) of the second fixation member 702.

In an embodiment, with reference to FIG. 2A, FIG. 2C, and the later described FIG. 3B and FIG. 5C, the first-first side surface 740-1 and the first-second side surface 740-2 may extend from the second side surface 750 in a direction inclined to the second side surface 750. The first-first side surface 740-1 and the first-second side surface 740-2 may be formed in a shape that is symmetric with respect to the second side surface 750.

In an embodiment, with reference to FIG. 2A, FIG. 2C, and the later described FIG. 3B and FIG. 5C, the third-first side surface 760-1, the third-second side surface 760-2, and the fourth side surface 770 of the protrusion 710 may be formed on the second surface 700b (e.g., surface facing the −y-axis in FIG. 2A) of the fixation member 700. The third-first side surface 761-1, the third-second side surface 761-2, and the fourth side surface 771 of the first protrusion 711 may be formed on the second surface 701b (e.g., surface facing the −y-axis in FIG. 2A) of the first fixation member 701. The third-first side surface 762-1, the third-second side surface 762-2, and the fourth side surface 772 of the second protrusion 712 may be formed on the second surface 702b (e.g., surface facing the −y-axis in FIG. 2A) of the second fixation member 702.

In an embodiment, with reference to FIG. 2A, FIG. 2C, and the later described FIG. 3B and FIG. 5C, the third-first side surface 760-1 and the third-second side surface 760-2 may extend from the fourth side surface 770 in a direction perpendicular to the fourth side surface 770 (e.g., x-axis direction in FIG. 2A). The third-first side surface 760-1 and the third-second side surface 760-2 may be formed in a shape that is symmetric with respect to the fourth side surface 770.

In an embodiment, the first-first side surface 740-1 and the first-second side surface 740-2 may be formed in a shape that is symmetric with respect to the second side surface 750, and the third-first side surface 760-1 and the third-second side surface 760-2 may be formed in a shape that is symmetric with respect to the fourth side surface 770. This symmetry allows the fixation member 700 to include the same operational form during rotation in the first direction (S1) or second direction (S2) of the wheel 300. For example, when the fixation member 700 is detached from at least a part of the first plate 400 and the second plate 600 due to the rotation of the wheel 300 in the first direction (S1) or second direction (S2), the length of the second housing 1000 may be adjusted. As a result, when adjusting the length of the second housing 1000, the user can experience a consistent feel of operation, making the user's operation more intuitive.

FIG. 3A is a view illustrating the assembled state of the first plate 400 and fixation member 700 of the length adjustment device 1100 according to an example embodiment. FIG. 3B is a view illustrating the state where a second fixation member 702 of the length adjustment device 1100 is detached from the first plate 400, according to an example embodiment. FIG. 4A is a front view of the assembled state of the first plate 400, fixation member 700, and gear 500 of the length adjustment device 1100 according to an example embodiment. FIG. 4B is a cross-sectional view taken along the line 4b-4b illustrated in FIG. 4A.

In an embodiment, with reference to FIG. 4A and FIG. 4B, the gear 500 may include a first portion 520 and a second portion 530. The first portion 520 may extend from the second portion 530 in the +y-axis direction of FIG. 4A. In the following description, although the gear 500 is explained as being divided into the first portion 520 and the second portion 530, it is possible that the gear 500 is not physically separated. The first portion 520 and second portion 530 may have been conceptually separated for the convenience of describing the gear 500.

In an embodiment, with reference to FIG. 4A and FIG. 4B, the gear 500 may include a first surface 500a (e.g., surface facing the +y-axis in FIG. 4A) and the a second surface 500b (e.g., surface facing the −y-axis in FIG. 4A), which is an opposite surface of the first surface 500a. The first portion 520 of the gear 500 may include the first surface 500a (e.g., surface facing the +y-axis in FIG. 4A) and the second surface (not illustrated) (e.g., surface facing the −y-axis in FIG. 4A), which is an opposite surface of the first surface 500a. The second portion 530 of the gear 500 may include the first surface (not illustrated) (e.g., surface facing the +y-axis in FIG. 4A) and the second surface 500b (e.g., surface facing the −y-axis in FIG. 4A), which is an opposite surface of the first surface 500a.

In an embodiment, with reference to FIG. 2A, FIG. 4A, FIG. 4B, and the later described FIG. 5A and FIG. 5C, the first portion 520 (hub) may be disposed on the first plate 400 and second plate 600, where the fixation member 700 is disposed, and may adjust the length of the second housing 1000. In an embodiment, the first portion 520 of the gear 500 and the fixation member 700 may be coupled by fitting to the first plate 400 and second plate 600. The first surface 500a of the first portion 520 and the first surface 701a, 702a of the fixation member 700 may be disposed to face the first plate 400. The second surface (not illustrated) of the first portion 520 and the second surface 701b and 702b of the fixation member 700 may be disposed to face the second plate 600.

In an embodiment, with reference to FIG. 2A, FIG. 4A, FIG. 4B, and the later described FIG. 5A and FIG. 5C, the second portion 530 may include teeth (e.g., cogs) 510. The teeth 510 may be formed at predetermined intervals. The teeth 510 may engage with the toothed structure 1010 of the second housing 1000, allowing the length of the second housing 1000 to be adjusted when the gear 500 rotates. In an embodiment, the second portion 530 of the gear 500 may be coupled by fitting into the internal space 600c of the second plate 600. The second portion 530 may be coupled, directly or indirectly, by fitting into the second plate 600. The second surface 500b of the second portion 520 may be disposed to face the second plate 600.

In an embodiment, with reference to FIG. 3A to FIG. 4B, the first plate 400 may include a first surface 400a (e.g., surface facing the +y-axis in FIG. 3A) and the a second surface 400b (e.g., surface facing the −y-axis in FIG. 3A), which is an opposite surface of the first surface 400a.

In an embodiment, with reference to FIG. 3A, FIG. 3B, FIG. 4A, and FIG. 4B, the first surface 701a (e.g., surface facing the +y-axis in FIG. 3A) of the first fixation member 701 may be disposed on the second surface 400b (e.g., surface facing the −y-axis in FIG. 3A) of the first plate. In an embodiment, the first surface 702a of the second fixation member 702 may be disposed on the second surface 400b of the first plate.

In an embodiment, with reference to FIG. 3A and FIG. 3B, the first plate 400 may include a first seating groove 410 (e.g., a first groove, first recess, first hole, or gap) where the protrusion 710 of the fixation member 700 is disposed. The first seating groove 410 may include a first-first seating groove 411 where the first protrusion 711 of the first fixation member 701 is disposed, and a first-second seating groove 412 where the second protrusion 712 of the second fixation member 702 is disposed.

In an embodiment, the first surface 700a (e.g., surface facing the +y-axis in FIG. 4A) of the protrusion 710 of the fixation member 700 may be disposed on the second surface 400b (e.g., surface facing the −y-axis in FIG. 4A) of the first plate 400.

In an embodiment, with reference to FIG. 3A and FIG. 3B, the first seating groove 410 may be formed by being recessed in the +y-axis direction of FIG. 3A from the second surface 400b (e.g., surface facing the −y-axis in FIG. 3A) of the first plate 400.

In an embodiment, the first seating groove 410 may include an inclined section 4101 where the first-first side surface 740-1 and the first-second side surface 740-2 of the protrusion 710 of the fixation member 700 are disposed. The inclined section 4101 may be formed in a shape corresponding to the first-first side surface 740-1 and the first-second side surface 740-2 of the protrusion 710 of the fixation member 700.

In an embodiment, with reference to FIG. 3A and FIG. 3B, the first-first seating groove 411 may include a first inclined section 4111 where the first-first side surface 741-1 and the first-second side surface 741-2 of the first protrusion 711 of the first fixation member 701 are disposed. The first inclined section 4111 may be formed in a shape corresponding to the first-first side surface 741-1 and the first-second side surface 741-2 of the first fixation member 701.

In an embodiment, with reference to FIG. 3A and FIG. 3B, the first-second seating groove 412 may include a second inclined section 4121 where the first-first side surface 742-1 and the first-second side surface 742-2 of the second protrusion 712 of the second fixation member 702 are disposed. The second inclined section 4121 may be formed in a shape corresponding to the first-first side surface 742-1 and the first-second side surface 742-2 of the second fixation member 702.

In an embodiment, with reference to FIG. 4B, the first plate 400 may include a plurality of rotation grooves 420 between the first plate 400 and the first portion 520 of the gear 500.

In an embodiment, with reference to FIG. 4B, the plurality of rotation grooves 420 may be positioned on the same plane as the first seating groove 410.

In an embodiment, with reference to FIG. 4B, the plurality of rotation grooves 420 may include a pair of first rotation grooves 421 and a pair of second rotation grooves 422. The pair of first rotation grooves 421 may be each disposed in a diagonal direction with respect to the rotation axis (e.g., y-axis in FIG. 3B) of the first plate 400. The pair of second rotation grooves 422 may be each disposed in a diagonal direction with respect to the rotation axis (e.g., y-axis in FIG. 3B) of the first plate 400.

In an embodiment, with reference to FIG. 4B, the first rotation groove 421 and the second rotation groove 422 may be disposed to face each other with respect to the x-axis in FIG. 4B.

In an embodiment, when the first plate 400 rotates by the gap A1 or A2 of the rotation groove 420 around the rotation axis (e.g., y-axis in FIG. 4B), the first side surface 740 of the protrusion 710 of the fixation member 700 may move along the inclined section 4101.

In an embodiment, with reference to FIG. 4B, when the user rotates the wheel 300 in the first direction (S1) around the rotation axis (e.g., y-axis in FIG. 2B), the first plate 400 may rotate by the gap A1 (e.g., 4 degrees in the first direction (S1) based on the y-axis in FIG. 2A) of the first rotation groove 421 around the rotation axis (e.g., y-axis in FIG. 4B). While the first plate 400 rotates by the gap A1 of the first rotation groove 421 around the rotation axis (e.g., y-axis in FIG. 4B), the first-first side surface 741-1 of the first protrusion 711 of the first fixation member 701 may move along the first inclined section 4111 of the first-first seating groove 411, and the first-first side surface 742-1 of the second protrusion 712 of the second fixation member 702 may move along the second inclined section 4121 of the first-second seating groove 412.

In an embodiment, with reference to FIG. 4B, when the user rotates the wheel 300 in the second direction (S2) around the rotation axis (e.g., y-axis in FIG. 2B), the first plate 400 may rotate by the gap A2 (e.g., 4 degrees in the second direction (S2) based on the y-axis in FIG. 2A) of the second rotation groove 422 around the rotation axis (e.g., y-axis in FIG. 4B). While the first plate 400 rotates by the gap A2 of the second rotation groove 422 around the rotation axis (e.g., y-axis in FIG. 4B), the first-second side surface 741-2 of the first protrusion 711 of the first fixation member 701 may move along the first inclined section 4111 of the first-first seating groove 411, and the first-second side surface 742-2 of the second protrusion 712 of the second fixation member 702 may move along the second inclined section 4121 of the first-second seating groove 412.

In an embodiment, with reference to FIG. 3A, FIG. 3B, and FIG. 4B, the first plate 400 may include at least one first guide 430.

In an embodiment, with reference to FIG. 3A, FIG. 3B, and FIG. 4B, the first fixation member 701 and the second fixation member 702 may move in a straight line along the first guide 430 on the second surface 400b (e.g., surface facing the −y-axis in FIG. 3A) of the first plate 400.

In an embodiment, when the first-first side surface 740-1 and the first-second side surface 740-2 of the protrusion 710 of the fixation member 700 move along the inclined section 4101 of the first seating groove 410, the spring 730 (e.g., spring 730 in FIG. 2A) connecting the first fixation member 701 and the second fixation member 702 may be compressed.

In an embodiment, with reference to FIG. 2A, FIG. 3A, FIG. 3B, and FIG. 4B, when the first-first side surface 741-1 and the first-second side surface 741-2 of the first protrusion 711 of the first fixation member 701 move along the first inclined section 4111 of the first-first seating groove 411, and the first-first side surface 742-1 and the first-second side surface 742-2 of the second protrusion 712 of the second fixation member 702 move along the second inclined section 4121 of the first-second seating groove 412, the spring 730 (e.g., spring 730 in FIG. 2A) connecting the first fixation member 701 and the second fixation member 702 may be compressed.

In an embodiment, with reference to FIG. 2A, FIG. 3A, FIG. 3B, and FIG. 4B, when the spring 730 (e.g., spring 730 in FIG. 2A) is compressed, the first fixation member 701 may move in the +x-axis direction of FIG. 4B along the first guide 430. When the spring 730 (e.g., spring 730 in FIG. 2A) is compressed, the second fixation member 702 may move in the −x-axis direction of FIG. 4B along the first guide 430.

In an embodiment, when the spring 730 (e.g., spring 730 in FIG. 2A) connecting the first fixation member 701 and the second fixation member 702 is compressed, the protrusion 710 of the fixation member 700 may be detached from the first seating groove 410 or be disposed in (entirely or partially) at least a part of the first seating groove 410.

In an embodiment, with reference to FIG. 3A, FIG. 3B, and FIG. 4B, when the spring 730 (e.g., spring 730 in FIG. 2A) connecting the first fixation member 701 and the second fixation member 702 is compressed, the first protrusion 711 of the first fixation member 701 may be detached from the first-first seating groove 411 or be disposed in, partially or entirely, at least a part of the first-first seating groove 411, and the second protrusion 712 of the second fixation member 702 may be disposed in, partially or entirely, at least a part of the first-second seating groove 412 or detached from the first-second seating groove 412.

In an embodiment, when the protrusion 710 of the fixation member 700 is disposed in at least a part of the first seating groove 410 or detached from the first seating groove 410, the first portion 520 may be disposed in the pair of rotation grooves 420.

In an embodiment, with reference to FIG. 3A, FIG. 3B, and FIG. 4B, when the first plate 400 rotates in the first direction (S1) by the gap A1 (e.g., 4 degrees in the first direction (S1) based on the y-axis in FIG. 2A) of the first rotation groove 421 around the rotation axis (e.g., y-axis in FIG. 2B), the first-first side surface 741-1 of the first protrusion 711 of the first fixation member 701 may be disposed in at least a part of the first-first seating groove 411 or detached from the first-first seating groove 411. When the first plate 400 rotates in the first direction (S1) by the gap A1 (e.g., 4 degrees in the first direction (S1) based on the y-axis in FIG. 2A) of the first rotation groove 421 around the rotation axis (e.g., y-axis in FIG. 2B), the first-first side surface 742-1 of the second protrusion 712 of the second fixation member 702 may be disposed in at least a part of the first-second seating groove 412 or detached from the first-second seating groove 412. In this case, at least a part of the first portion 520 of the gear 500 may be disposed in the pair of first rotation grooves 421 and rotate around the rotation axis (e.g., y-axis in FIG. 4A). In an embodiment, when the first-first side surface 740-1 of the protrusion 710 of the fixation member 700 is disposed in at least a part of the first seating groove 410 and the first portion 520 of the gear 500 rotates, the user's feel of operation of the wheel 300 may be enhanced.

In an embodiment, with reference to FIG. 3A, FIG. 3B, and FIG. 4B, when the first plate 400 rotates in the second direction (S2) by the gap A2 of the second rotation groove 422 around the rotation axis (e.g., y-axis in FIG. 2B), the first-second side surface 741-2 of the first protrusion 711 of the first fixation member 701 may be disposed in at least a part of the first-first seating groove 411 or detached from the first-first seating groove 411. When the first plate 400 rotates in the second direction (S2) by the gap A2 of the second rotation groove 422 around the rotation axis (e.g., y-axis in FIG. 2B), the first-second side surface 742-2 of the second protrusion 712 of the second fixation member 702 may be disposed in at least a part of the first-second seating groove 412 or detached from the first-second seating groove 412. In this case, at least a part of the first portion 520 of the gear 500 may be disposed in the pair of second rotation grooves 422 and rotate around the rotation axis (e.g., y-axis in FIG. 4A). In an embodiment, when the first-second side surface 740-2 of the protrusion 710 of the fixation member 700 is disposed in at least a part of the first seating groove 410 and the first portion 520 of the gear 500 rotates, the user's feel of operation of the wheel 300 may be enhanced.

In an embodiment, with reference to FIG. 2A, FIG. 3A, FIG. 3B, and FIG. 4B, when the first portion 520 of the gear 500 is disposed in the pair of first rotation grooves 421 or second rotation grooves 422, the first portion 520 of the gear 500 may rotate by the same angle as the rotation angle of the wheel 300 and the first plate 400.

FIG. 5A is a front view of the assembled state of the gear 500, fixation member 700, and second plate 600 of the length adjustment device 1100 according to an example embodiment. FIG. 5B is a cross-sectional view taken along line 5b-5b illustrated in FIG. 5A. FIG. 5C is a top plan view of FIG. 5A.

In an embodiment, with reference to FIG. 5A, FIG. 5B, and FIG. 5C, the second plate 600 may include the first surface 600a (e.g., surface facing the +y-axis in FIG. 5A) and the a second surface 600b (e.g., surface facing the −y-axis in FIG. 5A), which is an opposite surface of the first surface.

In an embodiment, the second surface 700b (e.g., surface facing the −y-axis in FIG. 5A) of the protrusion 710 of the fixation member 700 may be disposed on the first surface 600a (e.g., surface facing the +y-axis in FIG. 5A) of the second plate 600.

In an embodiment, the first surface 700a (e.g., surface facing the +y-axis in FIG. 2A) of the protrusion 710 of the fixation member 700 is disposed in the first seating groove 410 of the first plate 400, and the second surface 700b (e.g., surface facing the −y-axis in FIG. 2A) of the protrusion 710 of the fixation member 700 is disposed in the second seating groove 610 of the second plate 600.

In an embodiment, with reference to FIG. 5A, FIG. 5B, and FIG. 5C, the second surface 701b (e.g., surface facing the −y-axis in FIG. 5A) of the first protrusion 711 of the first fixation member 701 and the second surface 702b (e.g., surface facing the −y-axis in FIG. 5A) of the second protrusion 712 of the second fixation member 702 may be disposed on the first surface 600a (e.g., surface facing the +y-axis in FIG. 5A) of the second plate 600.

In an embodiment, the second surface 700b (e.g., surface facing the −y-axis in FIG. 5A) of the body 720 of the fixation member 700 may be disposed on the first surface 500a (e.g., surface facing the +y-axis in FIG. 5A) of the first portion 520 of the gear 500.

In an embodiment, with reference to FIG. 5A, FIG. 5B, and FIG. 5C, the second surface 701b (e.g., surface facing the −y-axis in FIG. 5A) of the body 721 of the first fixation member 701 and the second surface 702b (e.g., surface facing the −y-axis in FIG. 5A) of the body 722 of the second fixation member 702 may be disposed on the first surface 500a (e.g., surface facing the +y-axis in FIG. 5A) of the first portion 520 of the gear 500.

In an embodiment, with reference to FIG. 5A, FIG. 5B, and FIG. 5C, the second plate 600 may include a plurality of second seating grooves 610 (e.g., a second groove, second recess, second hole, first portion groove, first portion wall) in which the protrusion 710 of the fixation member 700 is disposed.

In an embodiment, with reference to FIG. 5A, FIG. 5B, and FIG. 5C, the plurality of second seating grooves 610 may be formed by being recessed in the direction of the −y-axis in FIG. 5A from the first surface 600a (e.g., surface facing the +y-axis in FIG. 5A) of the second plate 600.

In an embodiment, with reference to FIG. 5A, FIG. 5B, and FIG. 5C, the second seating groove 610 may be formed as a plurality of grooves along the circumference of the second plate 600. The plurality of second seating grooves 610 may each be formed of the same shape.

In an embodiment, each of the plurality of second seating grooves 610 may be formed to correspond to the third-first side surface 760-1, the third-second side surface 760-2, and the fourth side surface 770 of the fixation member 700.

In an embodiment, with reference to FIG. 5A, FIG. 5B, and FIG. 5C, each of the plurality of second seating grooves 610 may be formed to correspond to the third-first side surface 761-1, the third-second side surface 761-2, and the fourth side surface 771 of the first fixation member 701.

In an embodiment, with reference to FIG. 5A, FIG. 5B, and FIG. 5C, the second seating groove 610 may include a first section 6101, a second section 6102, and a third section 6103.

In an embodiment, with reference to FIG. 5A, FIG. 5B, and FIG. 5C, the first section 6101 and the third section 6103 may be formed of a planar shape. The second section 6102 may be formed of a curved shape.

In an embodiment, with reference to FIG. 5A, FIG. 5B, and FIG. 5C, the first section 6101 may extend from the third section 6103. The second section 6102 may extend from the first section 6101.

In an embodiment, the third-first side surface 760-1 and the third-second side surface 760-2 of the protrusion 710 of the fixation member 700 may be disposed in the first section 6101. The fourth side surface 770 of the protrusion 710 of the fixation member 700 may be disposed in the third section 6103.

In an embodiment, with reference to FIG. 5A, FIG. 5B, and FIG. 5C, the third-first side surface 761-1 and the third-second side surface 761-2 of the first protrusion 711 of the first fixation member 701 may be disposed in the first section 6101. The fourth side surface 771 of the first protrusion 711 of the first fixation member 701 may be disposed in the third section 6103.

In an embodiment, the first section 6101 may be formed of a shape that corresponds to the third-first side surface 760-1 and the third-second side surface 760-2 of the protrusion 710 of the fixation member 700. The third section 6103 may be formed of a shape that corresponds to the fourth side surface 770 of the protrusion 710 of the fixation member 700.

In an embodiment, with reference to FIG. 5A, FIG. 5B, and FIG. 5C, the first section 6101 may be formed of a shape that corresponds to the third-first side surface 761-1 and the third-second side surface 761-2 of the first protrusion 711 of the first fixation member 701. The third section 6103 may be formed of a shape that corresponds to the fourth side surface 771 of the first protrusion 711 of the first fixation member 701.

In an embodiment, the body 720 of the fixation member 700 may be disposed on the first surface 500a (e.g., surface facing the +y-axis in FIG. 5B) of the first portion 520 of the gear 500.

In an embodiment, with reference to FIG. 5B, the body 721 of the first fixation member 701 and the body 722 of the second fixation member 702 may be disposed on the first surface 500a (e.g., surface facing the +y-axis in FIG. 5B) of the first portion 520 of the gear 500.

In an embodiment, with reference to FIG. 4B, FIG. 5A, FIG. 5B, and FIG. 5C, when the user rotates the wheel 300 in the first direction (S1) around the rotation axis (e.g., y-axis in FIG. 4B), the first plate 400 may rotate by the gap A1 (4 degrees in the first direction (S1) based on the y-axis in FIG. 2A) of the first rotation groove 421 around the rotation axis (e.g., y-axis in FIG. 4B). While the first plate 400 rotates by the gap A1 of the first rotation groove 421 around the rotation axis (e.g., y-axis in FIG. 4B), the first-first side surface 741-1 of the first protrusion 711 of the first fixation member 701 may move along the first inclined section 4111 of the first-first seating groove 411 of the first plate 400, and the third-first side surface 761-1 may move along the first section 6101 of the second plate 600. While the first plate 400 rotates by the amount of the gap A1 in the first rotation groove 421 around the rotation axis (e.g., y-axis in FIG. 4B), the first-first side surface 742-1 of the second protrusion 712 of the second fixation member 702 may move along the second inclined section 4121 of the first-second seating groove 412 of the first plate 400, and the third-first side surface 762-1 may move along the first section 6101 of the second plate 600.

In an embodiment, with reference to FIG. 4B, FIG. 5A, FIG. 5B, and FIG. 5C, when the user rotates the wheel 300 in the second direction (S2) around the rotation axis (e.g., y-axis in FIG. 4B), the first plate 400 may rotate by the gap A2 (e.g., 4 degrees in the second direction (S2) based on the y-axis in FIG. 2A) of the second rotation groove 422 around the rotation axis (e.g., y-axis in FIG. 4B). While the first plate 400 rotates by the gap A2 of the second rotation groove 422 around the rotation axis (e.g., y-axis in FIG. 4B), the first-second side surface 741-2 of the first protrusion 711 of the first fixation member 701 may move along the first inclined section 4111 of the first-first seating groove 411 of the first plate 400, and the third-second side surface 761-2 may move along the first section 6101 of the second plate 600. While the first plate 400 rotates by the gap A2 of the second rotation groove 422 around the rotation axis (e.g., y-axis in FIG. 4B), the first-second side surface 742-2 of the second protrusion 712 of the second fixation member 702 may move along the second inclined section 4121 of the first-second seating groove 412 of the first plate 400, and the third-second side surface 762-2 may move along the first section 6101 of the second plate 600.

In an embodiment, with reference to FIG. 5B and FIG. 5C, the first portion 520 may include at least one second guide 540.

In an embodiment, with reference to FIG. 5A, FIG. 5B, and FIG. 5C, the first fixation member 701 and the second fixation member 702 may move in a straight line along the second guide 540 on the first surface 500a (e.g., surface facing the +y-axis in FIG. 5A) of the first portion 520 of the gear 500.

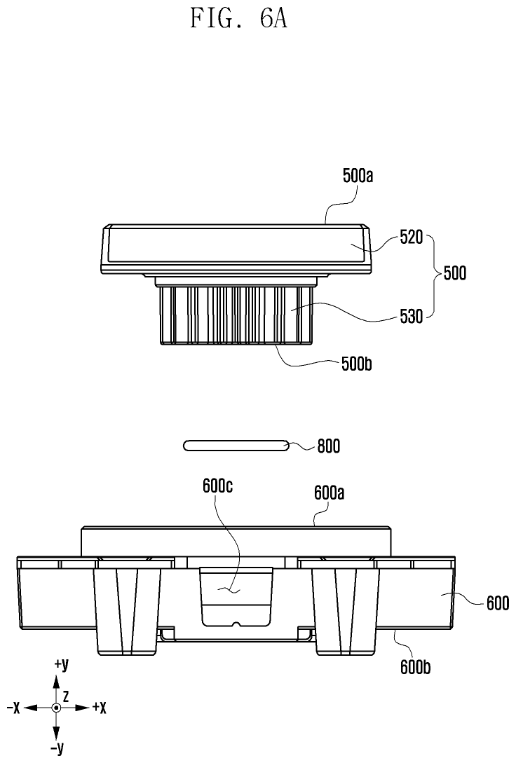

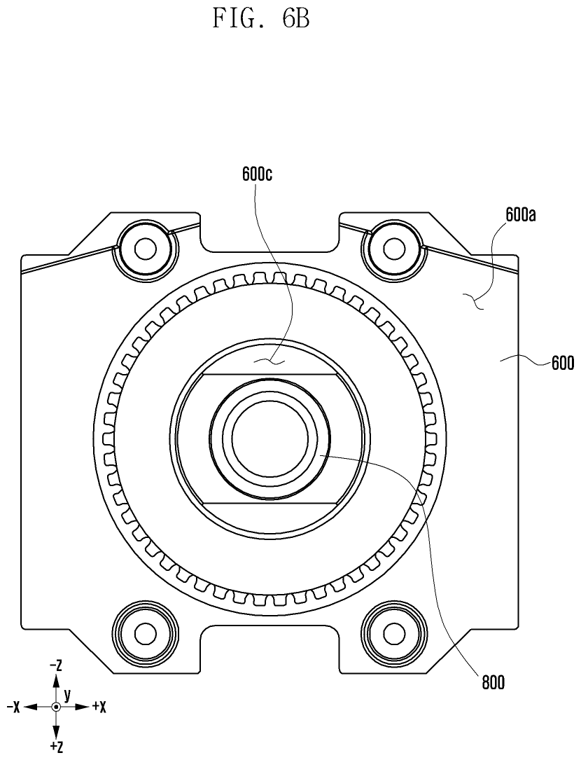

In an embodiment, with reference to FIG. 5B, FIG. 5C, and the later described FIG. 6A and FIG. 6B, the second portion 530 of the gear 500 may be disposed in the internal space 600c of the second plate 600.

In an embodiment, when the third-first side surface 760-1 and the third-second side surface 760-2 of the protrusion 710 of the fixation member 700 move along the first section 6101 to the second section 6102, the spring 730 (e.g., spring 730 in FIG. 2A) connecting the first fixation member 701 and the second fixation member 702 may be compressed.

In an embodiment, with reference to FIG. 2A, FIG. 5A, FIG. 5B, and FIG. 5C, when the third-first side surface 761-1 and the third-second side surface 761-2 of the first protrusion 711 of the first fixation member 701 move along the first section 6101 to the second section 6102, and the third-first side surface 762-1 and the third-second side surface 762-2 of the second protrusion 712 of the second fixation member 702 move along the first section 6101 to the second section 6102, the spring 730 (e.g., spring 730 in FIG. 2A) connecting the first fixation member 701 and the second fixation member 702 may be compressed.

In an embodiment, with reference to FIG. 2A, FIG. 5A, FIG. 5B, and FIG. 5C, when the spring 730 (e.g., spring 730 in FIG. 2A) is compressed, the first fixation member 701 may move in the +x-axis direction of FIG. 5C along the second guide 540. When the spring 730 (e.g., spring 730 in FIG. 2A) is compressed, the second fixation member 702 may move in the −x-axis direction of FIG. 5C along the second guide 540.

In an embodiment, when the first plate 400 rotates by the gap A1 or A2 of the rotation groove 420 around the rotation axis (e.g., y-axis in FIG. 2A) of the first plate 400, the first-first side surface 740-1 and the first-second side surface 740-2 of the protrusion 710 of the fixation member 700 move along the inclined sections 4111 and 4121 of the first seating groove 410 of the first plate 400, and the third-first side surface 760-1 and the third-second side surface 760-2 move to the second section 6102 of the second plate 600.

In an embodiment, when the third-first side surface 760-1 and the third-second side surface 760-2 of the protrusion 710 of the fixation member 700 move along the first section 6101 to the second section 6102, the spring 730 connecting the first fixation member 701 and the second fixation member 702 may be compressed.

In an embodiment, when the spring 730 connecting the first fixation member 701 and the second fixation member 702 is compressed, the protrusion 710 of the fixation member 700 may be detached from the second seating groove 610.

In an embodiment, when the protrusion 710 of the fixation member 700 is detached from the second seating groove 610, the first portion 520 of the gear 500 may rotate around the rotation axis (e.g., y-axis in FIG. 2A) of the first portion 520.

In an embodiment, with reference to FIG. 5A, FIG. 5B, and FIG. 5C, when the spring 730 connecting the first fixation member 701 and the second fixation member 702 is compressed, the first protrusion 711 of the first fixation member 701 and the second protrusion 712 of the second fixation member 702 may be disposed in at least a part of the second seating groove 610 or detached from the second seating groove 610.

In an embodiment, with reference to FIG. 5A, FIG. 5B, and FIG. 5C, when the first protrusion 711 of the first fixation member 701 and the second protrusion 712 of the second fixation member 702 are disposed in at least a part of the second seating groove 610 or detached from the second seating groove 610, the first portion 520 of the gear 500 may rotate around the rotation axis (e.g., y-axis in FIG. 5A) of the first portion 520.

In an embodiment, when the first surface 700a (e.g., surface facing the +y-axis in FIG. 2A) of the protrusion 710 of the fixation member 700 is disposed in at least a part of the first seating groove 410 of the first plate 400, and the second surface 700b (e.g., surface facing the −y-axis in FIG. 2A) of the protrusion 710 of the fixation member 700 is disposed in at least a part of the second seating groove 610 of the second plate 600, the first portion 520 of the gear 500 may be disposed in the pair of rotation grooves 420 of the first plate 400, allowing the first portion 520 of the gear 500 to rotate around the rotation axis (e.g., y-axis in FIG. 5A) of the first portion 520.

In an embodiment, when the first surface 700a (e.g., surface facing the +y-axis in FIG. 2A) of the protrusion 710 of the fixation member 700 is detached from the first seating groove 410 of the first plate 400, and the second surface 700b (e.g., surface facing the −y-axis in FIG. 2A) of the protrusion 710 of the fixation member 700 is detached from the second seating groove 610 of the second plate 600, the first portion 520 of the gear 500 may be disposed in the pair of rotation grooves 420 of the first plate 400, allowing the first portion 520 of the gear 500 to rotate around the rotation axis (e.g., y-axis in FIG. 5A) of the first portion 520.

In an embodiment, with reference to FIG. 3A, FIG. 3B, FIG. 4B, FIG. 5A, FIG. 5B, and FIG. 5C, when the first plate 400 rotates in the first direction (S1) by the gap A1 (e.g., 4 degrees in the first direction (S1) based on the y-axis in FIG. 5C) of the first rotation groove 421 around the rotation axis (e.g., y-axis in FIG. 5C), the first-first side surface 741-1 of the first protrusion 711 of the first fixation member 701 may be disposed in at least a part of the first-first seating groove 411 of the first plate 400, and the third-first side surface 761-1 may move to the second section 6102 of the second plate 600. When the first plate 400 rotates in the first direction (S1) by the gap A1 (e.g., 4 degrees in the first direction (S1) based on the y-axis in FIG. 5C) of the first rotation groove 421 around the rotation axis (e.g., y-axis in FIG. 5C), the first-first side surface 742-1 of the second protrusion 712 of the second fixation member 702 may be disposed in at least a part of the first-second seating groove 412, and the third-first side surface 762-1 may move to the second section 6102 of the second plate 600. In this case, the first portion 520 of the gear 500 may rotate in the first direction (S1) by the same angle as the rotation angle of the wheel 300 and the first plate 400. In an embodiment, when the first-first side surface 740-1 of the protrusion 710 of the fixation member 700 is disposed in at least a part of the first seating groove 410 of the first plate 400, and the third-first side surface 760-1 is disposed in at least a part of the second seating groove 610 of the second plate 600, allowing the first portion 520 of the gear 500 to rotate, the user's feel of operation of the wheel 300 may be enhanced.

In an embodiment, with reference to FIG. 3A, FIG. 3B, FIG. 4B, FIG. 5A, FIG. 5B, and FIG. 5C, when the first plate 400 rotates in the second direction (S2) by the gap A2 (e.g., 4 degrees in the second direction (S2) based on the y-axis in FIG. 5C) of the second rotation groove 422 around the rotation axis (e.g., y-axis in FIG. 5C), the first-second side surface 741-2 of the first protrusion 711 of the first fixation member 701 may be disposed in at least a part of the first-first seating groove 411 of the first plate 400, and the third-second side surface 761-2 may move to the second section 6102 of the second plate 600. When the first plate 400 rotates in the second direction (S2) by the gap A2 (e.g., 4 degrees in the second direction (S2) based on the y-axis in FIG. 5C) of the second rotation groove 422 around the rotation axis (e.g., y-axis in FIG. 5C), the first-second side surface 742-2 of the second protrusion 712 of the second fixation member 702 may be disposed in at least a part of the first-second seating groove 412, and the third-second side surface 762-2 may move to the second section 6102 of the second plate 600. In this case, the first portion 520 of the gear 500 may rotate in the second direction (S2) by the same angle as the rotation angle of the wheel 300 and the first plate 400. In an embodiment, when the first-second side surface 740-2 of the protrusion 710 of the fixation member 700 is disposed in at least a part of the first seating groove 410 of the first plate 400, and the third-second side surface 760-2 is disposed in at least a part of the second seating groove 610 of the second plate 600, allowing the first portion 520 of the gear 500 to rotate, the user's feel of operation of the wheel 300 may be enhanced.

In an embodiment, with reference to FIG. 3A, FIG. 3B, FIG. 4B, FIG. 5A, FIG. 5B, and FIG. 5C, when the first plate 400 rotates in the first direction (S1) by the gap A1 (e.g., 4 degrees in the first direction (S1) based on the y-axis in FIG. 5C) of the first rotation groove 421 around the rotation axis (e.g., y-axis in FIG. 5C), the first-first side surface 741-1 of the first protrusion 711 of the first fixation member 701 may be detached from the first-first seating groove 411 of the first plate 400, and the third-first side surface 761-1 may be disposed in the second section 6102 of the second plate 600. When the first plate 400 rotates in the first direction (S1) by the gap A1 (e.g., 4 degrees in the first direction (S1) based on the y-axis in FIG. 5C) of the first rotation groove 421 around the rotation axis (e.g., y-axis in FIG. 5C), the first-first side surface 742-1 of the second protrusion 712 of the second fixation member 702 may be detached from the first-second seating groove 412, and the third-first side surface 762-1 may be disposed in the second section 6102 of the second plate 600. In this case, the first portion 520 of the gear 500 may rotate in the first direction (S1) by the same angle as the rotation angle of the wheel 300 and the first plate 400.

In an embodiment, with reference to FIG. 3A, FIG. 3B, FIG. 4B, FIG. 5A, FIG. 5B, and FIG. 5C, when the first plate 400 rotates in the second direction (S2) by the gap A2 (e.g., 4 degrees in the second direction (S2) based on the y-axis in FIG. 5C) of the second rotation groove 422 around the rotation axis (e.g., y-axis in FIG. 5C), the first-second side surface 741-2 of the first protrusion 711 of the first fixation member 701 may be detached from the first-first seating groove 411 of the first plate 400, and the third-second side surface 761-2 may be disposed in the second section 6102 of the second plate 600. When the first plate 400 rotates in the second direction (S2) by the gap A2 (e.g., 4 degrees in the second direction (S2) based on the y-axis in FIG. 5C) of the second rotation groove 422 around the rotation axis (e.g., y-axis in FIG. 5C), the first-second side surface 742-2 of the second protrusion 712 of the second fixation member 702 may be detached from the first-second seating groove 412, and the third-second side surface 762-2 may be disposed in the second section 6102 of the second plate 600. In this case, the first portion 520 of the gear 500 may rotate in the second direction (S2) by the same angle as the rotation angle of the wheel 300 and the first plate 400.

In an embodiment, when the first portion 520 of the gear 500 rotates around the rotation axis (e.g., y-axis in FIG. 2A), the second portion 530, which extends from the first portion 520, may rotate. The teeth 510 formed on the second portion 530 may engage with the toothed structure 1010 of the second housing 1000 through the open internal space 600c of the second plate 600, allowing the length of the second housing 1000 to be adjusted.

In an embodiment, when the wheel 300 rotates in the first direction (S1) around the rotation axis (e.g., y-axis in FIG. 2A) of the wheel 300, the length of the second housing 1000 may be adjusted in an increasing direction.

In an embodiment, when the wheel 300 rotates in the second direction (S2) around the rotation axis (e.g., y-axis in FIG. 2A) of the wheel 300, the length of the second housing 1000 may be adjusted in a decreasing direction.

In an embodiment, when the first portion 520 rotates around the rotation axis (e.g., y-axis in FIG. 2A), the angle of the second housing 1000 may be adjusted.

In an embodiment, when the wheel 300 rotates in the first direction (S1) around the rotation axis (e.g., y-axis in FIG. 2A) of the wheel 300, the angle of the second housing 1000 may be adjusted in an increasing direction.

In an embodiment, when the wheel 300 rotates in the second direction (S2) around the rotation axis (e.g., y-axis in FIG. 2A) of the wheel 300, the angle of the second housing 1000 may be adjusted in a decreasing direction.

In an embodiment, when the user stops the operation of the wheel 300, the spring 730 connecting the first fixation member 701 and the second fixation member 702 may return to its original length before compression.

In an embodiment, when the spring 730 returns to its original length before compression, the protrusion 710 of the fixation member 700 may be disposed in the first seating groove 410.

In an embodiment, when the spring 730 returns to its original length before compression, the protrusion 710 of the fixation member 700 may be disposed in the second seating groove 610.

In an embodiment, when the protrusion 710 of the fixation member 700 is disposed in the first seating groove 410, the first portion 520 may be separated from the pair of rotation grooves 420.

In an embodiment, when the protrusion 710 of the fixation member 700 is disposed in the second seating groove 610, the rotation of the first portion 520 may be stopped.

In an embodiment, when the rotation of the first portion 520 is stopped, the adjustment of the length of the second housing 1000 may also be stopped.

In an embodiment, when the user applies force to the second housing 1000, the protrusion 710 of the fixation member 700 may be fixed in the first seating groove 410 and the second seating groove 610.

In an embodiment, due to the protrusion 710 of the fixation member 700 being fixed in the first seating groove 410 and the second seating groove 610, the spring 730 connecting the first fixation member 701 and the second fixation member 702 may maintain its original length before compression.

In an embodiment, when the user applies force to the second housing 1000, it may involve the user pulling or pushing the second housing 1000.

In an embodiment, when the user applies force to the second housing 1000, the protrusion 710 of the fixation member 700 may maintain its disposed state in the first seating groove 410.

In an embodiment, when the user applies force to the second housing 1000, the protrusion 710 of the fixation member 700 may maintain its disposed state in the second seating groove 610.

In an embodiment, when the protrusion 710 of the fixation member 700 is disposed in the first seating groove 410 and the second seating groove 610, the first portion 520 may be fixed.

In an embodiment, when the first portion 520 is fixed, the length of the second housing 1000 may be fixed.

In an embodiment, as the user rotates the wheel 300 around the rotation axis (e.g., y-axis in FIG. 2A) of the wheel 300, when the first side surface 740 of the protrusion 710 of the fixation member 700 moves out of the inclined section 4101, the user's feel of operation of the wheel 300 may be reduced.

In an embodiment, as the user rotates the wheel 300 around the rotation axis (e.g., y-axis in FIG. 2A) of the wheel 300, when the third side surface 760 of the protrusion 710 of the fixation member 700 moves out of the second section 6102, the user's feel of operation of the wheel 300 may be reduced.

In an embodiment, when the user stops the operation of the wheel 300 (e.g., wheel 300 in FIG. 2A), and the spring 730 connecting the first fixation member 701 and the second fixation member 702 returns to its original length before compression, the speed at which the spring 730 returns to its original length before compression may be fast.

In an embodiment, when the spring 730 returns to its original length before compression at a fast speed, noise may occur when the spring 730 returns to its original length before compression, and the protrusion 710 of the fixation member 700 is disposed in the first seating groove 410.

In an embodiment, when the spring 730 returns to its original length before compression at a fast speed, noise may occur when the spring 730 returns to its original length before compression, and the protrusion 710 of the fixation member 700 is disposed in the second seating groove 610.

FIG. 6A is a view illustrating the assembly of the gear 500, rubber ring 800, and second plate 600 of the length adjustment device 1100, according to an example embodiment. FIG. 6B is a top plan view of FIG. 6A.

In an embodiment, with reference to FIG. 2A and FIG. 6A, at least one rubber ring 800 (e.g., an O-ring, first elastic member) may be disposed between the gear 500 and the second plate 600.

In an embodiment, with reference to FIG. 2A and FIG. 6A, at least one rubber ring 800 may be disposed between the second portion 530 and the second plate 600.

In an embodiment, when the first plate 400 (e.g., first plate 400 in FIG. 2A) rotates around the rotation axis (e.g., y-axis in FIG. 2A) in the first plate 400, the rubber ring 800 may reduce the speed at which the third side surface 760 of the protrusion 710 of the fixation member 700 moves along the first section 6101 to the second section 6102 of the second plate 600.

In an embodiment, when the speed at which the third side surface 760 of the protrusion 710 of the fixation member 700 moves along the first section 6101 to the second section 6102 is reduced, the speed at which the spring 730 connecting the first fixation member 701 and the second fixation member 702 is compressed may also be reduced.

In an embodiment, when the speed at which the spring 730 connecting the first fixation member 701 and the second fixation member 702 is compressed is reduced, the speed at which the protrusion 710 of the fixation member 700 is detached from the second seating groove 610 may be also reduced.

In an embodiment, when the speed at which the protrusion 710 of the fixation member 700 is detached from the second seating groove 610 is reduced, the speed at which the first portion 520 rotates around the rotation axis (e.g., y-axis in FIG. 2A) in the first portion 520 may be reduced.

In an embodiment, the rubber ring 800 may reduce the noise generated while the user operates the wheel 300 (e.g., wheel 300 in FIG. 2A).

In an embodiment, the rubber ring 800 may reduce the noise generated when the spring 730 returns to its original length before compression, and the protrusion 710 of the fixation member 700 is disposed in the first seating groove 410.

In an embodiment, the rubber ring 800 may reduce the noise generated when the spring 730 returns to its original length before compression, and the protrusion 710 of the fixation member 700 is disposed in the second seating groove 610.

In an embodiment, when the user stops operating the wheel 300 (e.g., the wheel 300 in FIG. 2A), the rubber ring 800 may reduce the noise generated while the rotation of the first portion 520 is slowly stopped and the first portion 520 rotates.

In an embodiment, with reference to FIG. 2A to FIG. 5C, as the user rotates the wheel 300 around the rotation axis (e.g., y-axis in FIG. 2A) of the wheel 300, when the first side surface 740 of the protrusion 710 of the fixation member 700 positions and moves along the inclined section 4101, the protrusion 710 of the fixation member 700 may be disposed in at least a part of the first seating groove 410 of the first plate 400 in response to the user's operation of the wheel 300.

In an embodiment, with reference to FIG. 2A to FIG. 5C, as the user rotates the wheel 300 around the rotation axis (e.g., y-axis in FIG. 2A) of the wheel 300, when the third side surface 760 of the protrusion 710 of the fixation member 700 positions and moves along the second section 6102 out of the first section 6101, the protrusion 710 of the fixation member 700 may be disposed in at least a part of the second seating groove 610 of the second plate 600 in response to the user's operation of the wheel 300.

In an embodiment, when the user rotates the wheel 300 around the rotation axis (e.g., y-axis in FIG. 2A) of the wheel 300 while the protrusion 710 of the fixation member 700 is disposed in at least a part of the first seating groove 410 of the first plate 400, the protrusion 710 of the fixation member 700 may be disposed in at least a part of the second seating groove 610 of the second plate 600.

In an embodiment, the plurality of second seating grooves 610 of the second plate 600 may correspond to a plurality of gear grooves (not illustrated) of the gear 500.

In an embodiment, when the user rotates the wheel 300 around the rotation axis (e.g., y-axis in FIG. 2A) in the wheel 300 while the protrusion 710 of the fixation member 700 is disposed in at least a part of the second seating groove 610 of the second plate 600, the feel of operation of the wheel 300 for the user may be formed in response to the rotation of the first portion 520 around the rotation axis (e.g., y-axis in FIG. 2A).

The following description will omit the explanation of configurations that are the same or similar to those described above and will be replaced by the explanation through FIG. 2A to FIG. 6B.

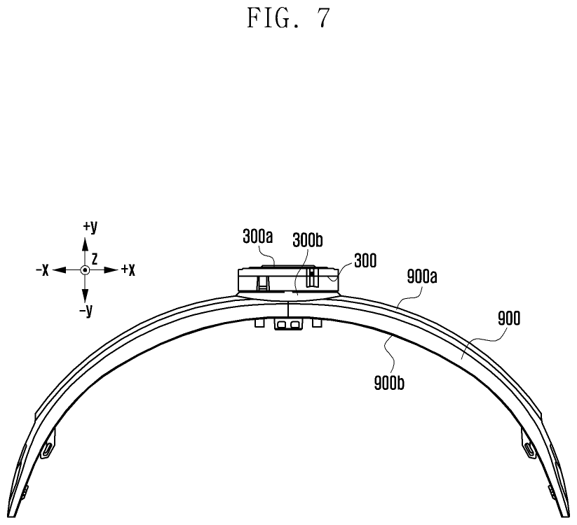

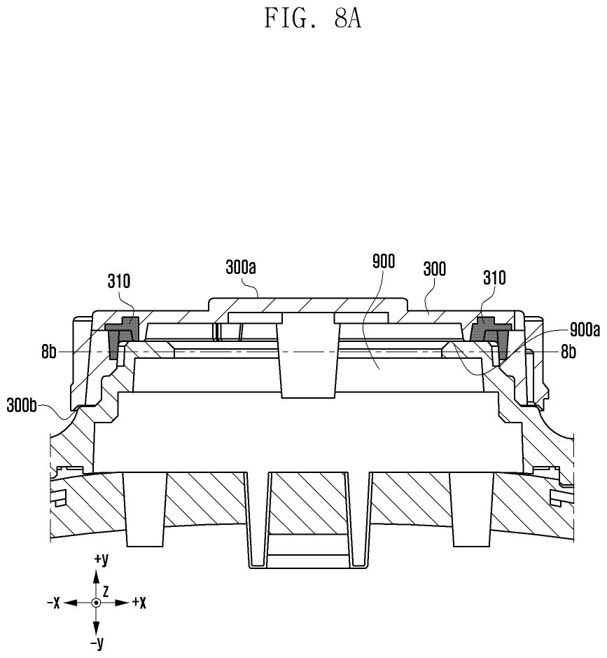

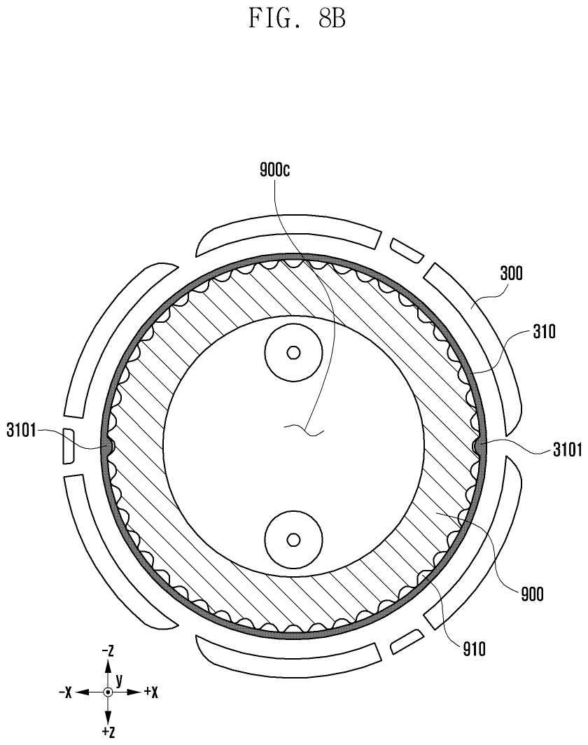

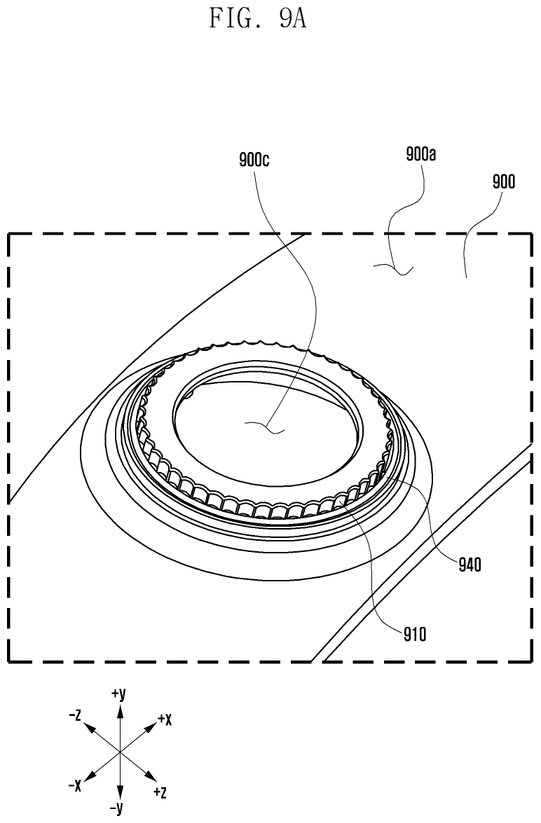

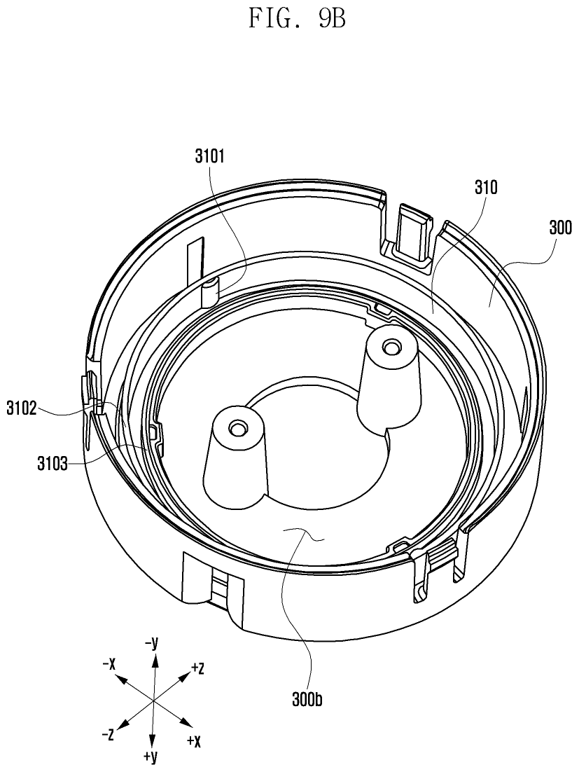

FIG. 7 is a front view of the assembled state of the wheel and first housing of the length adjustment device, according to an example embodiment. FIG. 8A is an enlarged front view of the assembled state of the wheel, elastic member, and first housing of the length adjustment device, according to an example embodiment. FIG. 8B is a cross-sectional view taken along line 8b-8b illustrated in FIG. 8A. FIG. 9A is an enlarged top plan view of the first housing in FIG. 8A. FIG. 9B is an enlarged bottom view of the wheel in FIG. 8A.

In an embodiment, with reference to FIG. 7 to FIG. 9B, the length adjustment device 1100 may include the first housing 900 in which the wheel 300 is disposed.

In an embodiment, with reference to FIG. 8A and FIG. 8B, the wheel 300 may include a first surface 300a and the a second surface 300b, which is an opposite surface of the first surface 300a.

In an embodiment, the wheel 300 may include an elastic member 310 (e.g., a second elastic member). In an embodiment, the elastic member 310 may be disposed on the second surface 300b of the wheel 300.

In an embodiment, with reference to FIG. 8A to FIG. 9B, the elastic member 310 may be disposed between the wheel 300 and the first housing 900.

In an embodiment, the elastic member 310 may be disposed between the circumference of the first housing 900 and the circumference of the wheel 300.

In an embodiment, the elastic member 310 may be formed of an elastic material (e.g., rubber, silicone, or polyurethane).

In an embodiment, with reference to FIG. 9A, the first housing 900 may include a protruding structure 940.

In an embodiment, the second surface 300b of the wheel 300 may be disposed on the protruding structure 940.

In an embodiment, the elastic member 310 may be disposed between the protruding structure 940 of the first housing 900 and the circumference of the wheel 300.

In an embodiment, the protruding structure 940 may include a plurality of third seating grooves 910 (e.g., third groove, third recess, third hole, second portion groove, second portion wall) along the circumference of the first housing 900.

In an embodiment, the number of the plurality of third seating grooves 910 may correspond to the number of the plurality of second seating grooves 610 of the second plate 600 (e.g., second plate 600 in FIG. 2A).

In an embodiment, the plurality of second seating grooves 610 of the second plate 600 may correspond to a plurality of gear grooves (not illustrated) of the gear 500.

In an embodiment, the elastic member 310 may be in contact with at least a part of the third seating groove 910.

In an embodiment, the elastic member 310 may include at least one elastic protrusion 3101 that protrudes in the direction of the rotation axis (e.g., y-axis in FIG. 2A) of the wheel 300.

In an embodiment, the elastic protrusion 3101 may be formed in a shape that corresponds to the third seating groove 910.

In an embodiment, the elastic protrusion 3101 may be in contact with the third seating groove 910.

In an embodiment, when the user rotates the wheel 300 around the rotation axis (e.g., y-axis in FIG. 2A) of the wheel 300 while the elastic protrusion 3101 is disposed in the third seating groove 910, the user may feel the operation of the wheel 300 in response to the rotation of the first portion 520 around the rotation axis (e.g., y-axis in FIG. 2A).

The following description will omit the explanation of configurations that are the same or similar to those described above and will be replaced by the explanation through FIG. 2A to FIG. 6B.

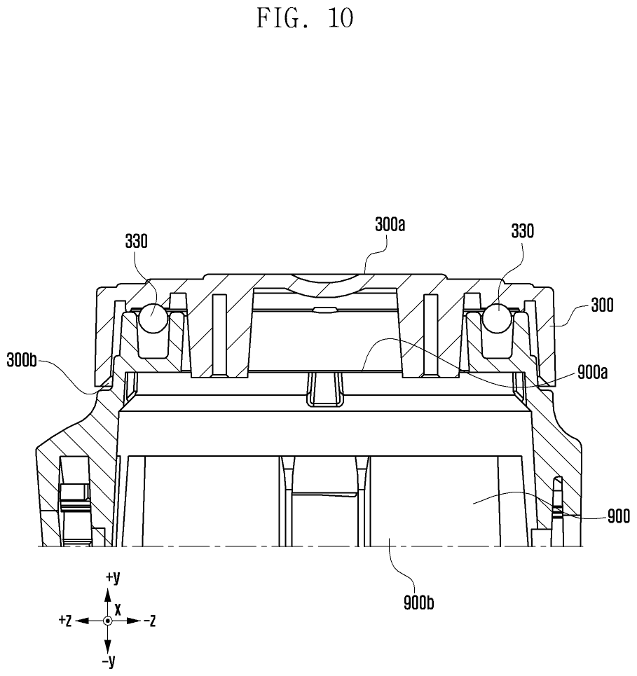

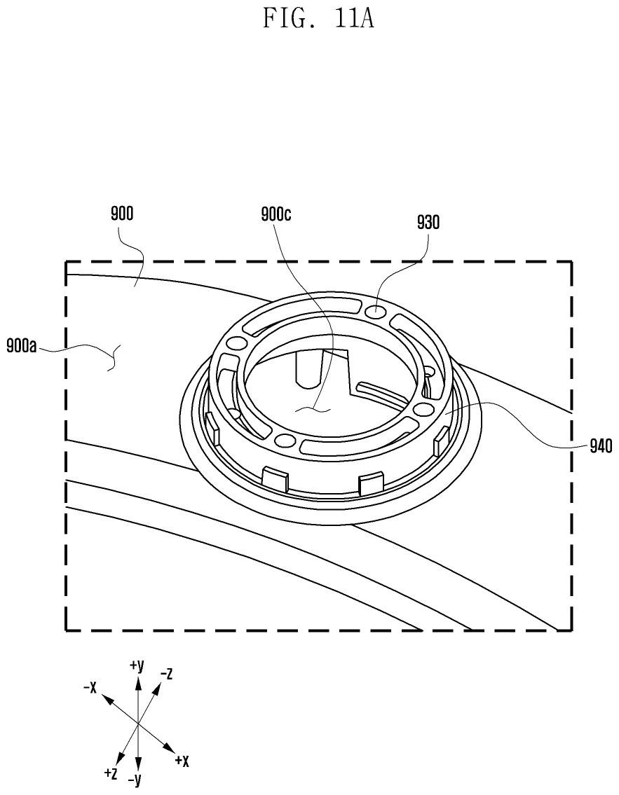

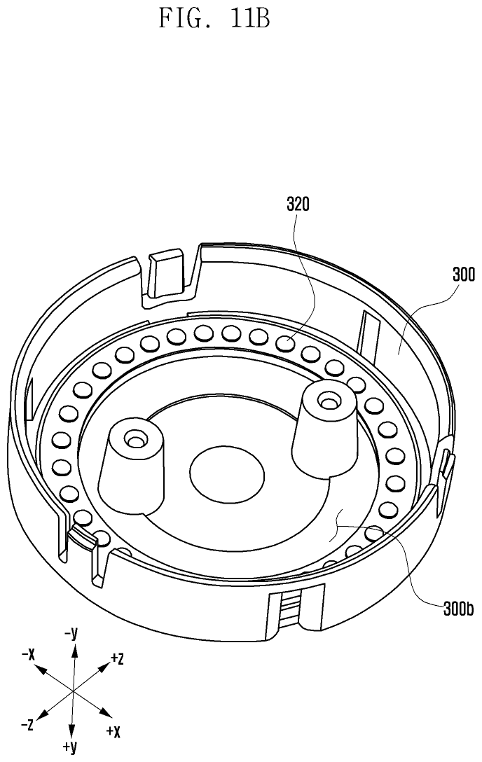

FIG. 10 is an enlarged front view of the assembled state of the wheel, ball, and first housing of the length adjustment device, according to an example embodiment. FIG. 11A is an enlarged top plan view of the first housing in FIG. 10. FIG. 11B is an enlarged bottom view of the wheel in FIG. 10.

In an embodiment, the wheel 300 may include a plurality of fourth seating grooves 320 (e.g., fourth groove, fourth recess, fourth hole, rail, or injection rail) along the circumference of the wheel 300.

In an embodiment, the number of the plurality of fourth seating grooves 320 may correspond to half the number of the plurality of second seating grooves 610 of the second plate 600 (e.g., second plate 600 in FIG. 2A).

In an embodiment, the plurality of second seating grooves 610 of the second plate 600 may correspond to a plurality of gear grooves (not illustrated) of the gear 500.

In an embodiment, at least one ball 330 with a spherical shape may be disposed between the fourth seating groove 320 and the protruding structure 940.

In an embodiment, the ball 330 may be formed in a shape that corresponds to the fourth seating groove 320.

In an embodiment, when the user rotates the wheel 300 around the rotation axis (e.g., y-axis in FIG. 2A) of the wheel 300 while the elastic protrusion 3101 is disposed between the fourth seating groove 320 and the protruding structure 940, the user's feel of operation of the wheel 300 may exist on the first portion 520 in response to the rotation of the first portion 520 around the rotation axis (e.g., y-axis in FIG. 2A).

The following description will omit the explanation of configurations that are the same or similar to those described above and will be replaced by the explanation through FIG. 2A to FIG. 9B.

A head mountable display device 100 or 1100 according to an example embodiment may include a wheel 300, a first plate 400 coupled, directly or indirectly, to the wheel and comprising a first seating groove 410, a gear 500 having a first surface 500a disposed at, directly or indirectly, the first plate, a second plate 600 disposed at, directly or indirectly, the a second surface 500b of the gear, which is an opposite surface of the first surface of the gear, and comprising a plurality of second seating grooves 610 along a circumference, and a fixation member 700 having a first surface 700a and the a second surface 700b which is an opposite surface of the first surface of the fixation member, wherein the fixation member comprises a protrusion 710, at least a portion of the first surface of the fixation member disposed in (entirely or partially) the first seating groove, and at least a portion of the second surface of the fixation member disposed in (entirely or partially) one of the plurality of second seating grooves, and a body 720 extending from the protrusion.

In an embodiment, the gear may include a first portion 520 that is disposed on, directly or indirectly, the first plate, and a second portion 530 that is disposed on, directly or indirectly, the second plate 600.

In an embodiment, the first plate may include a plurality of rotation grooves 420 disposed between at the first plate and the first portion, and wherein the plurality of rotation grooves may include a pair of first rotation grooves 421 disposed in a diagonal direction with respect to a rotation axis of the wheel, and a pair of second rotation grooves 422 that faces the pair of first rotation groove.

In an embodiment, the wheel and protrusion are configured so that as the wheel rotates in a first direction (S1) around the rotation axis by a gap of the pair of first rotation grooves, the protrusion may be detached from the first seating groove and the second seating groove, allowing the gear to rotate.

In an embodiment, the wheel and protrusion are configured so that as the wheel 300 rotates in a second direction (S2), which is an opposite direction of the first direction (S1), around the rotation axis by the gap of the pair of second rotation grooves, the protrusion may be detached from the first seating groove and the second seating groove, allowing the gear to rotate.

In an embodiment, the first seating groove may include an inclined section 4101 where the protrusion is detached, and the second seating groove may include a first section 6101 with a planar shape and a second section 6102, which extends from the first section and comprises a curved shape.

In an embodiment, the protrusion are configured so that as the wheel rotates around the rotation axis by the gap of one of the plurality of rotation groove, the protrusion may be positioned in the inclined section and the second section.

In an embodiment, the head mountable display device may further include at least one rubber ring 800 between at least the gear and the second plate.

In an embodiment, the wheel and the first plate may be coupled by at least a screw.

In an embodiment, the first plate and the first portion of the gear may be coupled at least by fitting, and the second plate and the second portion of the gear may be coupled at least by fitting.

In an embodiment, the fixation member may include a first fixation member 701 and a second fixation member 702, which comprises a symmetrical shape relative to the first fixation member 701 based on the rotation axis of the wheel.

In an embodiment, the first fixation member and the second fixation member may be connected by at least a spring 730.

In an embodiment, the first fixation member and the second fixation member may configure to move along at least one first guide 430 of the first plate.

In an embodiment, the first fixation member and the second fixation member may configure to move along at least one second guide 540 of the gear.

In an embodiment, the head mountable display device may further include a first housing 900 that includes a protruding structure 940, on which the wheel is disposed, and wherein the wheel comprises a first surface 300a, and a second surface 300b, which is on opposite surface of the first surface of the wheel.

In an embodiment, the protruding structure may include a plurality of third seating grooves 910 along a circumference, corresponding to the number of the plurality of second seating grooves, and the wheel may include an elastic member 310 that contacts at least a portion of the plurality of third seating grooves at the second surface of the wheel.

In an embodiment, the wheel may include a plurality of fourth seating grooves 320 along a circumference, where the number of the fourth seating grooves is half of the number of the plurality of second seating grooves, and at least one ball 330 with a spherical shape disposed between the plurality of fourth seating groove and the protruding structure.

In an embodiment, the head mountable display device may further include a second housing 1000 disposed on, directly or indirectly, a second surface 600b of the second plate, which is an opposite surface of a first surface 600a of the second plate.

In an embodiment, the second housing may configure to have a length adjusted as the gear rotates around the rotation axis.

In an embodiment, the second housing may configure to have an angle adjusted as the gear rotates around the rotation axis.

Each embodiment herein may be used in combination with any other embodiment(s) described herein.

The head mountable display device according to various embodiments disclosed in this document may take various forms of devices. The head mountable display device may include, for example, portable communication devices (e.g., smartphones), computer devices (e.g., laptops), portable multimedia devices, portable medical devices, cameras, wearable devices, or home appliances. The head mountable display device according to the embodiments of this document is not limited to the aforementioned devices.

The embodiments of the present disclosure disclosed in the present specification and illustrated in the drawings are provided as particular examples for easily explaining the technical contents according to the embodiment of the present disclosure and helping understand the embodiment of the present disclosure, but not intended to limit the scope of the embodiment of the present disclosure. Accordingly, the scope of the various embodiments of the present disclosure should be interpreted as including all alterations or modifications derived from the technical spirit of the various embodiments of the present disclosure in addition to the disclosed embodiments.

### DESCRIPTION OF REFERENCE NUMERALS

| | |
|---|---|
| 1100: Head mountable display device and | 310: Elastic member |
| Length adjustment device | 330: Ball |
| 1000: Second housing | 410: First seating groove |
| 300: Wheel | 420: Rotation groove |
| 320: Fourth seating groove | 600: Second plate |
| 400: First plate | 6101: First section |
| 4101: Inclined section | 700: Fixation member |
| 500: Gear | 720: Body |
| 610: Second seating groove | 900: First housing |
| 6102: Second section | 940: Protruding structure |
| 710: Protrusion | |
| 800: Rubber ring | |
| 910: Third seating groove | |

1. A head mountable display device, comprising:
a wheel;
a first plate coupled to the wheel and comprising a first seating groove;
a gear having a first surface disposed at the first plate;
a second plate disposed at a second surface of the gear, which is an opposite surface of the first surface of the gear, and comprising a plurality of second seating grooves along a circumference; and
a fixation member having a first surface and a second surface which is an opposite surface of the first surface of the fixation member,
wherein the fixation member comprises:
a protrusion, at least a portion of the first surface of the fixation member disposed in the first seating groove, and at least a portion of the second surface of the fixation member disposed in one of the plurality of second seating grooves, and
a body extending from the protrusion.

2. The head mountable display device of claim 1, wherein the gear comprises:
a first portion disposed on the first plate, and
a second portion disposed on the second plate.

3. The head mountable display device of claim 2, wherein the first plate comprises a plurality of rotation grooves disposed between at least the first plate and the first portion, and
wherein the plurality of rotation grooves comprises:
a pair of first rotation grooves disposed in a diagonal direction with respect to a rotation axis of the wheel, and
a pair of a second rotation grooves facing each of the pair of first rotation grooves.

4. The head mountable display device of claim 3, wherein the wheel and protrusion are configured so that as the wheel rotates in a first direction around the rotation axis by a gap of the pair of first rotation grooves, the protrusion is detached from the first seating groove and one of the plurality of second seating grooves, allowing the gear to rotate.

5. The head mountable display device of claim 3, wherein the wheel and protrusion are configured so that as the wheel rotates in a second direction, which is an opposite direction of the first direction, around the rotation axis by a gap of the pair of second rotation grooves, the protrusion is detached from the first seating groove and one of the plurality of second seating grooves, allowing the gear to rotate.

6. The head mountable display device of claim 3, wherein the first seating groove comprises an inclined section where the protrusion is detached, and
wherein each of the plurality of second seating grooves comprises:
a first section with a planar shape, and
a second section extending from the first section and comprising a curved shape.

7. The head mountable display device of claim 6, wherein the protrusion is configured to be positioned in the inclined section and the second section as the wheel rotates around the rotation axis by a gap of one of the plurality of rotation grooves.

8. The head mountable display device of claim 1, further comprising:
at least one rubber ring between at least the gear and the second plate.

9. The head mountable display device of claim 1, wherein the wheel and the first plate are coupled by at least a screw.

10. The head mountable display device of claim 2, wherein the first plate, the second plate, and the first portion of the gear are coupled at least by fitting, and the second plate and the second portion of the gear are coupled at least by fitting.

11. The head mountable display device of claim 1, wherein the fixation member comprises:
a first fixation member, and
a second fixation member comprising a symmetrical shape relative to the first fixation member based on a rotation axis of the wheel.

12. The head mountable display device of claim 11, wherein the first fixation member and the second fixation member are connected by at least a spring.

13. The head mountable display device of claim 11, wherein the first fixation member and the second fixation member are configured to move along at least one first guide of the first plate.

14. The head mountable display device of claim 11, wherein the first fixation member and the second fixation member are configured to move along at least one second guide of the gear.

15. The head mountable display device of claim 1, further comprising:
a first housing that comprises a protruding structure on which the wheel is disposed, and
wherein the wheel comprises:
a first surface, and
a second surface, which is on opposite surface of the first surface of the wheel.

16. The head mountable display device of claim 15, wherein the protruding structure comprises a plurality of third seating grooves along a circumference, corresponding to the number of the plurality of second seating grooves, and
wherein the wheel comprises an elastic member that contacts at least a portion of the plurality of third seating grooves at the second surface of the wheel.

17. The head mountable display device of claim 15, wherein the wheel comprises:
a plurality of fourth seating grooves along a circumference, where the number of the fourth seating grooves is half the number of the plurality of second seating grooves; and
at least one spherical ball with a spherical shape disposed between the plurality of fourth seating grooves and the protruding structure.

18. The head mountable display device of claim 1, further comprising:
a second housing disposed on a second surface of the second plate, which is an opposite surface of a first surface of the second plate.

19. The head mountable display device of claim 18, wherein the second housing is configured to have a length adjusted as the gear rotates around a rotation axis thereof.

20. The head mountable display device of claim 18, wherein the second housing is configured to have an angle adjusted as the gear rotates around a rotation axis thereof.
